(19) United States
(12) Patent Application Publication
(10) Pub. No.: US 2026/0022221 A1
(43) Pub. Date: Jan. 22, 2026

(54) LAMINATE AND RESIN MOLDED BODY CONTAINING SAME

(71) Applicant: KANEKA CORPORATION, Osaka (JP)

(72) Inventors: Fujio Ishimaru, Osaka (JP); Hanako Hasebe, Osaka (JP); Haruki Koyama, Osaka (JP); Yukihiro Shimamoto, Tokyo (JP)

(73) Assignee: KANEKA CORPORATION, Osaka (JP)

(21) Appl. No.: 19/341,306

(22) Filed: Sep. 26, 2025

Related U.S. Application Data
(63) Continuation of application No. PCT/JP2024/010061, filed on Mar. 14, 2024.

(30) Foreign Application Priority Data
Mar. 30, 2023 (JP) 2023-056035

(51) Int. Cl. C08J 7/04; B32B 1/00; B32B 27/08; B32B 27/18; B32B 27/30; C08K 5/17; C09D 7/48; C09D 7/63; C09D 175/14

(52) U.S. Cl. CPC C08J 7/0427; B32B 1/00; B32B 27/08; B32B 27/18; B32B 27/308; C09D 7/48; C09D 7/63; C09D 175/14; B32B 2250/02; B32B 2250/246; B32B 2307/536; B32B 2307/71; C08J 2351/00; C08J 2433/12; C08J 2475/14; C08K 5/17

(57) ABSTRACT

A laminate includes an acrylic resin film; and a hard coat layer laminated on at least one surface of the acrylic resin film. The acrylic resin film has a tensile elongation at break of 200% or more at 120° C. The hard coat layer is formed from a cured product of a curable resin composition containing a urethane acrylate resin and a hindered amine light stabilizer having a reactive functional group. The laminate has a tensile crack elongation of 100% or more at 120° C.

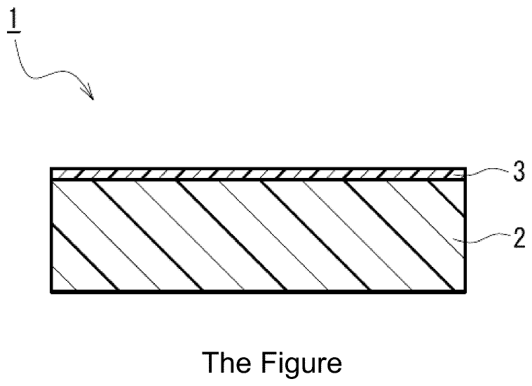

### TECHNICAL FIELD

One or more embodiments of the present invention relate to a laminate including an acrylic resin film and a resin molded body containing the laminate.

### BACKGROUND

Acrylic resin films have excellent transparency, weather resistance, high moldability that enables them to be laminated along the surface of a substrate having a flat and/or three-dimensional shape, and adhesion to other substrates, adhesiveness, printability, and the like. Therefore, acrylic resin films are widely used in a variety of applications such as surface protection and/or coloring, and decoration of automobile interior members, automobile exterior members, optical components, home appliance components, exterior members for buildings, retroreflective materials, and the like. In addition, when acrylic resin films are applied to these applications, a hard coat layer is provided for the purpose of further improving surface hardness, scratch resistance, chemical resistance against various solvents and chemical materials, and the like. For example, Patent Document 1 describes a hard coat film having a substrate formed from an acrylic resin film and a hard coat layer made of an electron beam-cured product of an electron beam-curable resin composition containing an electron beam-curable resin and a triazine-based ultraviolet absorber. In addition, Patent Document 2 describes a laminate comprising: an acrylic resin film; and a hard coat layer laminated on at least one surface of the acrylic resin film, the hard coat layer containing a urethane acrylate resin, and having a crack elongation of 80% or more at 120° C.

### PATENT DOCUMENT

[Patent Document 1] JP 2012-207120A
[Patent Document 2] WO 2022/185815

However, in the hard coat film described in Patent Document 1, in which the hard coat layer is provided on the acrylic resin film, the flexibility of the acrylic resin film is inhibited by the hard coat layer having a high degree of crosslinking, resulting in poor secondary moldability, and thus there are limitations on surface shapes of objects on which the hard coat film can be laminated. Moreover, in the case of the laminate described in Patent Document 2, for example, in the interior and exterior of an automobile or the like, the long-term weather resistance in applications where it is exposed to sunlight or wind and rain is not necessarily sufficient, and there is a need for further improvement.

### SUMMARY

One or more embodiments of the present invention have been made in view of the above-mentioned issues, and provides a laminate that has good transparency, surface hardness, and chemical resistance, has high secondary moldability, and also has excellent long-term weather resistance and can be used for surface protection of a resin molded body having a flat and/or three-dimensional surface, and a resin molded body including the same.

One or more embodiments of the present invention relate to a laminate comprising: an acrylic resin film; and a hard coat layer laminated on at least one surface of the acrylic resin film, wherein the acrylic resin film has a tensile elongation at break of 200% or more at 120° C., the hard coat layer is formed from a cured product of a curable resin composition comprising a urethane acrylate resin and a hindered amine light stabilizer having a reactive functional group, and the laminate has a tensile crack elongation of 100% or more at 120° C.

One or more embodiments of the present invention relate to a resin molded body comprising: the laminate; and a thermoplastic resin substrate, wherein at least a portion of the thermoplastic resin substrate surface is covered with the laminate located as the acrylic resin film side of the laminate is faced to a thermoplastic resin substrate surface.

One or more embodiments of the present invention provide a laminate that has good transparency, surface hardness, and chemical resistance, has high secondary moldability, and also has excellent long-term weather resistance and can be used for surface protection of a resin molded body having a flat and/or three-dimensional surface, and a resin molded body including the same.

### BRIEF DESCRIPTION OF THE DRAWING

The FIGURE is a schematic cross-sectional view of a laminate of one or more embodiments of the present invention.

### DETAILED DESCRIPTION

Inventors of one or more embodiments of the present invention have conducted intensive studies to resolve the above-mentioned issues. As a result, the inventors have surprisingly found that, in a laminate including an acrylic resin film and a hard coat layer, by using the acrylic resin film having specific physical properties and forming the hard coat layer from a cured product of a specific curable resin composition containing a urethane acrylate resin and a hindered amine light stabilizer having a reactive functional group, the laminate has good transparency, surface hardness, and chemical resistance, and has improved secondary moldability and long-term weather resistance.

Specifically, the laminate according to one or more embodiments of the present invention has a tensile crack elongation of 100% or more at 120° C. and high secondary moldability, and can be suitably used for the molded body having, for example, a curved shape and/or a three-dimensional shape. In addition, by forming the hard coat layer from a cured product of a specific curable resin composition containing a urethane acrylate resin and a hindered amine light stabilizer having a reactive functional group, the laminate according to one or more embodiments of the present invention has improved long-term weather resistance. In particular, even when the laminate according to one or more embodiments of the present invention is subjected to an accelerated weather resistance test (hereinafter also simply referred to as “accelerated weathering test”), in which the laminate is placed such that the hard coat layer side is located on the light source side, and a xenon lamp is used as a light source, and 1000 test cycles (2000 hours in total) are performed under a condition of irradiance of 180 W/m² (300 to 400 nm), where one test cycle for 120 minutes in total includes a step 1 with an exposure time of 102 minutes, a black panel at 60° C.±3° C., a relative humidity of 65%±5%, and no rain, and a step 2 with an exposure time of 18 minutes, a chamber temperature of 38° C.±3° C., a relative humidity of 95% 5%, and with rain, no cracks are formed on a surface of the hard coat layer.

In the present specification, a numerical range indicated by “ . . . to . . . ” includes two end values (upper and lower limits). For example, a numerical range indicated by “X to Y” includes two end values of X and Y, and is the same range as “X or more and Y or less”. In addition, any number within the above range or any range included in the range is specifically disclosed. Also, in the present specification, when a plurality of numerical ranges are mentioned, the numerical ranges include appropriate combinations of upper and lower limits of different numerical ranges.

### Acrylic Resin Film

An acrylic resin film has a tensile elongation at break of 200% or more at 120° C. This increases the tensile crack elongation at 120° C. of the laminate with the hard coat layer and tends to improve the secondary moldability of the laminate. There is no particular limitation on the upper limit of the tensile elongation at break at 120° C. of the acrylic resin film.

A composition of the acrylic resin film is not particularly limited as long as the acrylic resin film has a tensile elongation at break of 200% or more at 120° C., and the acrylic resin film may be formed from an acrylic resin composition containing an acrylic resin and graft copolymer particles containing a rubber component (also referred to as a cross-linked elastomer).

### Acrylic Resin

Conventionally known acrylic resins can be used as the acrylic resin as appropriate. For example, from the viewpoint of hardness and moldability, it is preferable to use an acrylic resin (also referred to as a thermoplastic acrylic polymer) containing methyl methacrylate units in an amount of 50% by mass to 100% by mass and other constitutional units in an amount of 0% by mass to 50% by mass, where a total amount of the constitutional units of the acrylic resin is 100% by mass. Note that a total amount of methyl methacrylate units and other constitutional units in the thermoplastic acrylic polymer is 100% by mass.

Examples of the other constitutional units include constitutional units derived from acrylic acid, acrylic acid derivatives, methacrylic acid, methacrylic acid derivatives, aromatic vinyl derivatives, and vinyl cyanide derivatives. The other constitutional units may be, for example, a glutarimide structure, a lactone ring structure, an a structure based on a structure based on N-substituted maleimide, and a structure based on unsubstituted maleimide, which will be described later. The other structural units contained in the acrylic resin may be of one type or a combination of two or more types.

Examples of the acrylic acid derivatives include, but are not limited to, acrylic acid esters such as methyl acrylate, ethyl acrylate, n-propyl acrylate, n-butyl acrylate, isobutyl acrylate, cyclohexyl acrylate, 2-hydroxyethyl acrylate, 2-phenoxyethyl acrylate, benzyl acrylate, and glycidyl acrylate.

Examples of the metacrylic acid derivatives include, but are not limited to, methacrylic acid esters such as ethyl methacrylate, n-propyl methacrylate, n-butyl methacrylate, isobutyl methacrylate, phenyl methacrylate, benzyl methacrylate, cyclohexyl methacrylate, 2-phenoxyethyl methacrylate, and isobornyl methacrylate, as well as reactive ultraviolet absorbers described below.

Examples of the aromatic vinyl derivatives include, but are not limited to, styrene, vinyltoluene, and α-methylstyrene.

Examples of the vinyl cyanide derivatives include, but are not limited to, acrylonitrile and methaycrylonitrile.

In order to improve the heat resistance, rigidity, surface hardness, and the like of the acrylic resin, a constitutional unit having a specific structure may be introduced into the acrylic resin through copolymerization, functional group modification, denaturation, or the like. Examples of such specific structures include glutarimide structures as shown in JP S62-89705A, JP H02-178310A, WO 2005/54311, and the like, lactone ring structures as shown in JP 2004-168882A, JP 2006-171464A, and the like, glutaric anhydride structures obtained through thermal cyclocondensation of (meth)acrylic acid units as shown in JP 2004-307834A and the like, maleic anhydride structures as shown in JP H5-119217A, and the structure based on N-substituted maleimide and the structure based on unsubstituted maleimide as shown in WO 2009/84541. For example, by introducing these structures into acrylic resin, molecular chains become rigid. As a result, it is expected that the acrylic resin has effects such as improved heat resistance, improved surface hardness, reduced heat shrinkage, and improved chemical resistance.

There is no particular limitation on a method for manufacturing the acrylic resin, and for example, known polymerization methods such as a known suspension polymerization method, a bulk polymerization method, a solution polymerization method, and an emulsion polymerization method can be used. In addition, any of known radical polymerization method, living radical polymerization method, anionic polymerization method, and cationic polymerization method can be used.

In 100% by mass of the acrylic resin film, the content of the acrylic resin may be 20% by mass to 100% by mass, 20% by mass to 99% by mass, 25% by mass to 95% by mass, or 30% by mass to 90% by mass.

### Graft Copolymer Containing Rubber Component

The acrylic resin film may contain, as graft copolymer particles containing a rubber component, graft copolymer particles (A) having an average particle size of 20 to 200 nm. In this case, in the acrylic resin film, the graft copolymer particles (A) may be dispersed in a matrix containing an acrylic resin or an acrylic resin and other components. In addition, the acrylic resin film may contain, as graft copolymer particles containing a rubber component, in addition to the graft copolymer particles (A), graft copolymer particles (B) having an average particle size larger than that of the graft copolymer particles (A) as needed. In this case, in the acrylic resin film, the graft copolymer particles (A) and the graft copolymer particles (B) may be dispersed in a matrix containing an acrylic resin or an acrylic resin and other components.

The graft copolymer particles (A) may have a core-shell structure (multilayer structure) including a crosslinked elastomer (A1) that is a rubber component and a graft polymer layer (A2) located on the surface layer side relative to the crosslinked elastomer (A1).

The crosslinked elastomer (A1) may be a known crosslinked elastomer. The crosslinked elastomer (A1) may be an acrylic acid ester-based crosslinked elastomer (a crosslinked elastomer constituted by a polymer containing an acrylic acid ester as a main component). In the present specification, the term “main component” refers to a component whose content is 50% by mass or more.

Particles of the acrylic acid ester-based crosslinked elastomer (A1) may have a concentric spherical multilayer structure having a hard or semi-hard crosslinked resin layer inside the crosslinked elastomer layer. Examples of such hard or semi-hard crosslinked resin layers include hard crosslinked methacrylic resin particles as described in JP S55-27576A and the like, semi-hard crosslinked particles made of methyl methacrylate-acrylic acid ester-styrene as described in JP H4-270751A, and crosslinked rubber particles having a high degree of crosslinking. When the crosslinked elastomer includes such a hard or semi-hard crosslinked resin layer, improvements in transparency, color tone, and the like can be expected in some cases.

The graft copolymer particles (A) may have a core-shell structure formed by graft-polymerizing a monomer mixture that forms the graft polymer layer (A2) in the presence of particles of the above-described acrylic acid ester-based crosslinked elastomer (A1).

The average particle size of the graft copolymer particles (A) need only be 20 to 200 nm, may be 50 to 150 nm, or 50 to 120 nm. If the average particle size of the graft copolymer particles (A) is too small, the impact resistance and bending crack resistance of the acrylic resin film tend to decrease. If the average particle size of the graft copolymer particles (A) is too large, the transparency of the acrylic resin film tends to deteriorate and whitening tends to occur when the acrylic resin film is bent.

It is preferable to use, as the acrylic acid ester-based crosslinked elastomer (A1), crosslinked elastomer particles obtained by polymerizing a monomer mixture (a-1) containing (a) an acrylic acid ester, (b) a polyfunctional monomer copolymerizable with the acrylic acid ester and having two or more non-conjugated double bonds per molecule, and (c) optionally other vinyl-based monomer copolymerizable with the acrylic acid ester.

The acrylic acid ester, the other vinyl-based monomer, and the polyfunctional monomer may all be mixed together and polymerized in one step. In addition, for the purpose of adjusting the toughness, whitening resistance, and the like of the acrylic resin film, compositions of the acrylic acid ester, the other vinyl-based monomer, and the polyfunctional monomer may be changed as appropriate, or the compositions may be kept the same, and the acrylic acid ester, the other vinyl-based monomer, and the polyfunctional monomer may be polymerized in two or more steps.

From the viewpoint of high polymerizability, low cost, ability to provide a polymer with a low Tg, and the like, an aliphatic ester of acrylic acid is preferable as an acrylic acid ester, an acrylic acid alkyl ester is more preferable, and an acrylic acid alkyl ester whose alkyl group has 1 to 22 carbon atoms is particularly preferable. Alkyl groups may have any structure such as a linear, branched, or cyclic (also referred to as alicyclic) structure.

Specific examples of acrylic acid alkyl ester may include methyl acrylate, ethyl acrylate, propyl acrylate, n-butyl acrylate, isobutyl acrylate, 2-ethylhexyl acrylate, n-octyl acrylate, isobornyl acrylate, cyclohexyl acrylate, dodecyl acrylate, stearyl acrylate, heptadecyl acrylate, and octadecyl acrylate. These may be used alone or in combination of two or more.

The amount of the acrylic acid ester (which may be an acrylic acid alkyl ester, or an acrylic acid alkyl ester whose alkyl group has 1 to 22 carbon atoms) may be 50% by mass to 99.9% by mass, 70% by mass to 99% by mass, or 80% by mass to 99% by mass, when the amount of the monomer mixture (a-1) is 100% by mass. When the amount of the acrylic acid ester is 50% by mass or more, the acrylic resin film has good impact resistance and good tensile elongation at break, and is less susceptible to cracking during secondary molding.

Examples of other vinyl-based monomer include methacrylic acid esters such as methyl methacrylate, ethyl methacrylate, propyl methacrylate, n-butyl methacrylate, isobutyl methacrylate, t-butyl methacrylate, phenyl methacrylate, benzyl methacrylate, cyclohexyl methacrylate, phenoxyethyl methacrylate, isobornyl methacrylate, and dicyclopentenyl methacrylate; vinyl cyanide derivatives such as acrylonitrile and methacrylonitrile; aromatic vinyl derivatives such as styrene, vinyl toluene, and α-methylstyrene; acrylic acid; acrylic acid derivatives such as β-hydroxyethyl acrylate, phenoxyethyl acrylate, benzyl acrylate, and glycidyl acrylate; methacrylic acid; methacrylic acid derivatives such as β-hydroxyethyl methacrylate, dimethylaminoethyl methacrylate, and glycidyl methacrylate; maleic anhydride; maleic acid derivatives such as N-alkylmaleimide and N-phenylmaleimide. These may be used alone or in combination of two or more. In particular, from the viewpoint of weather resistance and transparency, the other vinyl-based monomer may be one or more monomers selected from the group consisting of methacrylic acid esters and aromatic vinyl derivatives.

In 100% by mass of the monomer mixture (a-1), the amount of the other vinyl-based monomer may be 0% by mass to 49.9% by mass, 0% by mass to 30% by mass, or 0% by mass to 20% by mass. When the amount of the other vinyl-based monomer exceeds 49.9% by mass, the impact resistance of the acrylic resin film is likely to decrease, tensile elongation at break is reduced, and a crack is likely to form during secondary molding in some cases.

It is possible to suitably use a monomer that is usually used as a crosslinking agent and/or a graft crosslinking agent as a polyfunctional monomer. It is possible to use, as the polyfunctional monomer, for example, allyl methacrylate, allyl acrylate, triallyl cyanurate, triallyl isocyanurate, diallyl phthalate, diallyl maleate, divinyl adipate, divinyl benzene, ethylene glycol dimethacrylate, propylene glycol dimethacrylate, diethylene glycol dimethacrylate, triethylene glycol dimethacrylate, trimethylolpropane trimethacrylate, polyethylene glycol dimethacrylate, and dipropylene glycol dimethacrylate. These polyfunctional monomers may be used alone or in combination of two or more.

The polyfunctional monomers that function as a graft crosslinking agent are more preferable because such polyfunctional monomers increase the number of graft bonds in a later-described graft polymer layer (A2) to a crosslinked elastomer (A1), resulting in good dispersibility of the graft copolymer particles (A) in the acrylic resin, improving the crack resistance of the acrylic resin film against tensile and bending deformation, and reducing stress whitening. As such a polyfunctional monomer that functions as a graft crosslinking agent, a polyfunctional monomer having an allyl group such as allyl methacrylate, allyl acrylate, triallyl cyanurate, triallyl isocyanurate, diallyl phthalate, and diallyl maleate are preferable, and allyl methacrylate, allyl acrylate, and the like are particularly preferable.

The amount of the polyfunctional monomer may be 0.1% by mass to 10% by mass, or 1.0% by mass to 4% by mass, in 100% by mass of the monomer mixture (a-1). From the viewpoint of the resistance to cracking and whitening caused by bending the acrylic resin film, and the fluidity of the resin during molding, the blend amount of the polyfunctional monomer may be within the above range.

For the purpose of increasing a graft covering efficiency of a later-described graft polymer layer (A2), the amount of the polyfunctional monomer in the acrylic acid ester-based crosslinked elastomer (A1) may be changed between the inside and the vicinity of the surface of the crosslinked elastomer (A1). Specifically, as described in Japanese Patent No. 1460364, Japanese Patent No. 1786959, and the like, if the content of the polyfunctional monomer that functions as a graft crosslinking agent in the vicinity of the surface of the crosslinked elastomer (A1) is larger than that in the inside of the crosslinked elastomer (A1), it is possible to improve a coverage of the graft copolymer particles (A) with a graft polymer layer, improve dispersibility in the acrylic resin, and suppress a decrease in crack resistance due to peeling at the interface between the graft copolymer particles (A) and the acrylic resin. Furthermore, since a sufficient coating can be obtained by a relatively small amount of the graft polymer layer (A2), it is expected that the blend amount of the graft copolymer particles (A) to introduce a predetermined amount of the crosslinked elastomer (A1) to the acrylic resin composition can be reduced, and therefore the melt viscosity of the acrylic resin composition can be reduced, and the melt processability, film processing accuracy, and surface hardness, and the like of the acrylic resin film can be improved.

A chain transfer agent may be used in addition to the monomer mixture (a-1), for the purpose of controlling the molecular weight and crosslink density of the acrylic acid ester-based crosslinked elastomer (A1) and for the purpose of controlling the thermal stability and the like by reducing the double bond terminals of the polymer accompanying the disproportionation termination reaction during polymerization. The chain transfer agent can be selected from agents usually used in radical polymerization. For example, monofunctional or polyfunctional mercaptan compounds having 2 to 20 carbon atoms, such as n-octyl mercaptan, n-dodecyl mercaptan, and t-dodecyl mercaptan; mercapto acids; thiophenol; carbon tetrachloride; or mixtures thereof are preferable as chain transfer agents. The amount of the chain transfer agent added may be 0 to 1.0 parts by mass, or 0 to 0.2 parts by mass, with respect to 100 parts by mass of the total amount of the monomer mixture (a-1).

Particles of the crosslinked elastomer (A1) may have a single layer structure constituted by the above-described acrylic acid ester-based crosslinked elastomer (A1), or may have a multilayer structure including two or more layers constituted by the above-described acrylic acid ester-based crosslinked elastomer (A1).

The particles of the crosslinked elastomer (A1) may have a multilayer structure in which at least one layer of the multilayer particles having a hard or semi-hard crosslinked resin layer contains the acrylic acid ester-based crosslinked elastomer (A1). Examples of monomers constituting the hard or semi-hard crosslinked resin layer include methacrylic acid esters such as methyl methacrylate, ethyl methacrylate, n-butyl methacrylate, isobutyl methacrylate, t-butyl methacrylate, benzyl methacrylate, and phenoxyethyl methacrylate; acrylic acid alkyl esters such as methyl acrylate, ethyl acrylate, propyl acrylate, n-butyl acrylate, isobutyl acrylate, t-butyl acrylate, 2-ethylhexyl acrylate, and n-octyl acrylate; aromatic vinyl derivatives such as styrene and α-methylstyrene; vinyl cyanide derivatives such as acrylonitrile; maleic anhydride; maleic acid derivatives such as maleimides; and polyfunctional monomers having two or more non-conjugated double bonds per molecule. Polyfunctional monomers that are similar to those used in the polymerization of the acrylic acid ester-based crosslinked elastomer (A1) layer can be used as the polyfunctional monomer. In particular, one or more selected from the group consisting of methyl methacrylate, n-butyl methacrylate, isobutyl methacrylate, t-butyl methacrylate, ethyl acrylate, n-butyl acrylate, isobutyl acrylate, t-butyl acrylate, styrene, acrylonitorile, and the like are preferable. During the polymerization of a hard or semi-hard crosslinked resin layer, in addition to these monomers, a chain transfer agent may be used in combination for the purpose of controlling the crosslink density and for the purpose of controlling the thermal stability and the like by reducing the double bond terminals of a polymer. Chain transfer agents that are similar to those used in the polymerization of the acrylic acid ester-based crosslinked elastomer (A1) layer can be used as the chain transfer agent. The amount of the chain transfer agent added may be 0 to 2 parts by mass, or 0 to 0.5 parts by mass, with respect to 100 parts by mass of the total amount of the monomer mixture that constitutes the hard or semi-hard crosslinked resin layer.

When the graft copolymer particles (A) have a two-layer structure of crosslinked elastomer (A1) particles serving as core particles and a graft polymer layer (A2), the graft copolymer particles (A) can be typically obtained by graft copolymerizing a monomer mixture (a-2) containing a methacrylic acid ester in an amount of 50% by mass to 100% by mass and another vinyl-based monomer copolymerizable with the methacrylic acid ester in an amount of 0% by mass to 50% by mass (provided that the total of the methacrylic acid ester and the other vinyl-based monomer is 100% by mass) in the presence of the particles of the crosslinked elastomer (A1) to form the graft polymer layer (A2).

The amount of the methacrylic acid ester in 100% by mass of the monomer mixture (a-2) may be 60% by mass or more, 80% by mass, 90% by mass or more, or 97% by mass or more, from the viewpoint of (a) ensuring compatibility with an acrylic resin matrix, and (b) suppressing a decrease in the toughness of the film due to solvent impregnation while the acrylic resin film is coated, and suppressing whitening and cracking caused by stretch of the firm during molding.

In the monomer mixture (a-2), examples of the methacrylic acid ester include methacrylic acid alkyl esters such as methyl methacrylate, ethyl methacrylate, propyl methacrylate, n-butyl methacrylate, isobutyl methacrylate, t-butyl methacrylate, hexyl methacrylate, cyclohexyl methacrylate, 2-ethylhexyl methacrylate, octyl methacrylate, phenyl methacrylate, and benzyl methacrylate. In particular, a methacrylic acid alkyl ester whose alkyl group has 1 to 4 carbon atoms is preferable.

In the monomer mixture (a-2), an acrylic acid alkyl ester whose alkyl group has 2 or more carbon atoms can be used as the other vinyl-based monomer. The acrylic acid alkyl ester whose alkyl group has 2 or more carbon atoms may be, for example, one or more selected from the group consisting of ethyl acrylate, propyl acrylate, n-butyl acrylate, isobutyl acrylate, t-butyl acrylate, hexyl acrylate, cyclohexyl acrylate, octyl acrylate, dodecyl acrylate, and stearyl acrylate, and the like, one or more selected from the group consisting of ethyl acrylate, n-butyl acrylate, isobutyl acrylate, and t-butyl acrylate, or n-butyl acrylate.

In the monomer mixture (a-2), it is also possible to use, as the other vinyl-based monomer, aromatic vinyl derivatives such as styrene and its nuclear-substituted derivatives, vinyl cyanide derivatives such as acrylonitrile, methacrylic acid and derivatives thereof, acrylic acid and derivatives thereof, N-substituted maleimides, maleic anhydride, methacrylamide, acrylamide, and the like.

The monomer mixture (a-2) may contain a reactive ultraviolet absorber as the other vinyl-based monomer. That is, the graft polymer layer (A2) may contain a constitutional unit derived from a reactive ultraviolet absorber. When the monomer mixture (a-2) contains a reactive ultraviolet absorber, an acrylic resin film having good weather resistance and chemical resistance can be easily obtained.

Any known reactive ultraviolet absorber can be used as the reactive ultraviolet absorber without any particular limitation. From the viewpoint of moldability and weather resistance of the acrylic resin film, the reactive ultraviolet absorber may be a compound represented by General Formula (1) below.

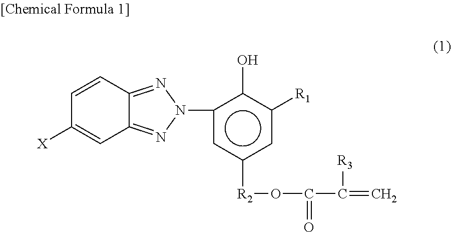

In General Formula (1), X represents a hydrogen atom or a halogen atom, R₁ represents a hydrogen atom, a methyl group, or a t-alkyl group having 4 to 6 carbon atoms, R₂ represents a linear or branched alkylene group having 2 to 10 carbon atoms, and R₃ represents a hydrogen atom or a methyl group.

Specifically, examples of the reactive ultraviolet absorber represented by General Formula (1) include 2-(2′-hydroxy-5′-(meth)acryloyloxyethylphenyl)-2H-benzotriazoles, and more specifically 2-(2′-hydroxy-5′-acryloyloxyethylphenyl)-2H-benzotriazole, 2-(2′-hydroxy-5′-methacryloyloxyethylphenyl)-2H-benzotriazole, 2-(2′-hydroxy-5′-methacryloyloxyethylphenyl)-5-chloro-2H-benzotriazole, 2-(2′-hydroxy-5′-methacryloyloxypropylphenyl)-2H-benzotriazole, and 2-(2′-hydroxy-5′-methacryloyloxyethyl-3′-t-butylphenyl)-2H-benzotriazole. 2-(2′-hydroxy-5′-methacryloyloxyethylphenyl)-2H-benzotriazole may be used in terms of cost and handleability. In the present specification, (meth)acryloyl is a general term for acryloyl and methacryloyl.

The content of constitutional units derived from the reactive ultraviolet absorber in 100% by mass of the graft polymer layer (A2) may be 0.01% by mass to 5% by mass, or 0.1% by mass to 3% by mass.

The graft polymer layer (A2) may be obtained by graft copolymerizing, in at least one stage, in the presence of 5 to 90 parts by mass of the crosslinked elastomer particles (A1), 10 to 95 parts by mass of the monomer mixture (a-2) containing a methacrylic acid alkyl ester in an amount of 70% by mass to 99.5% by mass, an acrylic acid alkyl ester whose alkyl group has 2 or more carbon atoms in an amount of 0.5% by mass to 30% by mass, and the other vinyl-based monomer in an amount of 0% by mass to 19% by mass (where the total of the methacrylic acid alkyl ester, the acrylic acid alkyl ester, and the other vinyl-based monomer is 100% by mass). However, it is presumed that the total amount of the particles of the crosslinked elastomer (A1) and the monomer mixture (a-2) is 100 parts by mass.

In the manufacturing of the graft copolymer particles (A), particularly, in the graft copolymerization of the monomer mixture (a-2) in the presence of particles of crosslinked elastomer (A1), for example, acrylic acid ester-based crosslinked elastomer (A1), a polymer component (free polymer) that is not graft-bonded to the particles of the acrylic acid ester-based crosslinked elastomer (A1) may be produced. Such a free polymer can be used as a component constituting a part or the entirety of the acrylic resin that constitutes the acrylic resin composition and a matrix phase of the acrylic resin film.

A chain transfer agent may be added to the monomer mixture (a-2), for the purposes of controlling the molecular weight of the polymer, controlling the graft ratio to the crosslinked elastomer (A1) and the amount of free polymer produced that is not bonded to the crosslinked elastomer (A1), and controlling thermal stability and the like by reducing the double bond terminals of the polymer accompanying the disproportionation termination reaction during polymerization. Chain transfer agents that are similar to chain transfer agents that can be used in the polymerization of the crosslinked elastomer (A1) can be used as such chain transfer agents. The amount of the chain transfer agent used may be 0 to 2 parts by mass, or 0 to 0.5 parts by mass, with respect to 100 parts by mass of the total amount of the monomer mixture (a-2).

The graft ratio of the monomer mixture (a-2) to the particles of the crosslinked elastomer (A1), i.e., the graft ratio of the graft copolymer particles (A), may be 5% to 250%, 10% to 200%, or 20% to 150%. When the graft ratio is less than 5%, there is a tendency that the acrylic resin film has reduced resistance to whitening upon bending, reduced transparency, and reduced tensile elongation at break, making the acrylic resin film more susceptible to cracking during secondary molding. When the graft ratio exceeds 250%, there is a tendency that the melt viscosity of the acrylic resin composition increases during film formation, and the moldability of the acrylic resin film decreases. In the present specification, the graft ratio of the graft copolymer particles (A) can be calculated using the following formula by dissolving the powder of the graft copolymer particles (A) in methyl ethyl ketone, separating the resulting mixture into an insoluble portion and a soluble portion, and presuming the insoluble portion to be a graft portion.

$$Graft ratio ( \% ) = ( mass of insoluble portion - mass of crosslinked elastomer ( A 1 ) ) / mass of crosslinked elastomer ( A 1 ) \times 100$$

An average particle size d (nm) of the acrylic acid ester-based crosslinked elastomer (A1) in the acrylic resin film and an amount w (% by mass) of a polyfunctional monomer used in the acrylic acid ester-based crosslinked elastomer (A1) may satisfy a relational formula: 0.015d≤w≤0.06d, or may satisfy a relational formula 0.02d≤w≤0.05d. When the amount of the polyfunctional monomer is in the range of the above relational formulas, the acrylic resin film has the following advantages: elongation during secondary molding of the acrylic acid-based resin film is unlikely to decrease, cracks are unlikely to form during molding or cutting, the acrylic resin film has excellent transparency, and stress whitening is unlikely to occur during bending or tensile deformation at room temperature (about 25° C.), at a high temperature that is higher than or equal to a softening temperature of the acrylic resin film, or in a temperature range between room temperature and the Tg of the crosslinked elastomer (A1), and the acrylic resin film is unlikely to become cloudy or white due to moisture that permeates through the acrylic resin film through the contact between the acrylic resin film and moisture.

Like the graft copolymer particles (A), the graft copolymer particles (B) also contain a crosslinked elastomer (B1), which is a rubber component. Like the graft copolymer particles (A), the graft copolymer particles (B) typically includes a graft polymer layer (B2) located on the surface layer side relative to the crosslinked elastomer (B1). That is, the graft copolymer particles (B) may include a crosslinked elastomer (B1) and a graft polymer layer (B2).

The graft copolymer particles (B) may be substantially similar to the graft copolymer particles (A) in terms of raw materials, a manufacturing method, and the like, except that the average particle size of the graft copolymer particles (B) is larger than that of the graft copolymer particles (A). Particles of the acrylic acid ester-based crosslinked elastomer (B1) may have a concentric spherical multilayer structure having a hard or semi-hard crosslinked resin layer inside the crosslinked elastomer layer. Examples of such hard or semi-hard crosslinked resin layers include hard crosslinked methacrylic resin particles as described in JP S55-27576A and the like, and crosslinked particles having a semi-hard layer made of a methyl methacrylate-acrylic acid ester-styrene copolymer as described in JP H4-270751A, WO 2014/41803, and the like. By introducing such a hard or semi-hard crosslinked resin layer, it is possible to improve the transparency, resistance to whitening upon bending, resistance to cracking upon bending, and the like of the graft copolymer particles (B) having a larger particle size than the graft copolymer particles (A).

The average particle size of the graft copolymer particles (B) may be 150 to 400 nm, or 200 to 350 nm. Graft copolymer particles (B) having a large average particle size more effectively induce plastic deformation (crazing) in the acrylic resin phase around the graft copolymer particles in response to the external force on the acrylic resin material. Therefore, the graft copolymer particles (B) are extremely effective in imparting impact resistance and crack resistance to the acrylic resin material. On the other hand, the graft copolymer particles (B) are inferior to the graft copolymer particles (A) in resistance to whitening due to bending and/or resistance to whitening due to solvents, and the like. Therefore, for example, by adding a small amount of the graft copolymer particles (B) to an acrylic resin composition containing an acrylic resin and graft copolymer particles (A), the following effects can be expected: (a) the surface hardness of the acrylic resin film and the laminate is not impaired by keeping the content of soft components in the acrylic resin film small; (b) stress whitening when external stress is applied to the acrylic resin film, blushing when coated the coating material containing an organic solvent, and/or whitening under molding process tend to be suppressed; and (c) the crack resistance, secondary moldability, and the like of the acrylic resin film and the laminate are efficiently improved.

In the present specification, the average particle sizes of the graft copolymer particles (A) and the graft copolymer particles (B) are each an average particle size on a volume basis (also referred to as a mass basis when the density is uniform), and can be measured in a latex state using a dynamic light scattering method by means of a laser diffraction particle size distribution measuring device such as Microtrac® particle size analyzer MT3000 manufactured by Nikkiso Co., Ltd.

There is no particular limitation on a method for manufacturing the graft copolymer particles (A) and the graft copolymer particles (B), and known methods such as an emulsion polymerization method, a mini-emulsion polymerization method, a suspension polymerization method, and a solution polymerization method can be used. The emulsion polymerization method is particularly preferable because it allows a wide range of adjustment of the resin structure.

Known initiators such as organic peroxides, inorganic peroxides, and azo compounds can be used as an initiator used in emulsion polymerization of the graft copolymer particles (A) and/or the graft copolymer particles (B). Specifically, examples thereof include organic peroxides such as t-butyl hydroperoxide, 1,1,3,3-tetramethylbutyl hydroperoxide, cumene hydroperoxide, benzoyl peroxide, lauroyl peroxide, alkyl peroxycarbonates, and alkyl peroxy esters; inorganic peroxides such as potassium persulfate, sodium persulfate, and ammonium persulfate; and azo compounds such as azobisisobutyronitrile. These may be used alone or in combination of two or more.

These initiators may be used as (a) thermal decomposition type radical polymerization initiators, or (b) a redox type polymerization initiator system in which these initiators are combined with a catalyst such as ferrous sulfate and a reducing agent such as sodium sulfite, sodium thiosulfate, sodium formaldehyde sulfoxylate, ascorbic acid, and hydroxyacetone acid. Note that the catalyst may be used as a complex with ethylenediaminetetraacetic acid disodium or the like to ensure water solubility.

There is no particular limitation on the surfactant (also referred to as “emulsifier”) used in emulsion polymerization of the graft copolymer particles (A) and/or the graft copolymer particles (B). A wide variety of known surfactants can be used in emulsion polymerization. Examples of surfactants may include, for example, (a) anionic surfactants such as sodium salts, potassium salts, and ammonium salts of alkyl sulfonic acids, alkyl benzene sulfonic acids, dialkyl sulfosuccinic acids (such as dioctyl sulfosuccinic acid), alkyl sulfates, fatty acid sodium, polyoxyethylene alkyl ether acetates, polyoxyethylene alkyl ether phosphates, alkyl phosphates, alkyl ether phosphates, alkyl phenyl ether phosphates, surfactin, and the like, and (b) nonionic surfactants such as reaction products of alkyl phenols and fatty alcohols with propylene oxide and/or ethylene oxide. These surfactants may be used alone or in combination of two or more.

The graft copolymer particles (A) or the graft copolymer particles (B) can be separated and collected using a known method from the latex of the graft copolymer particles (A) or the latex of the graft copolymer particles (B) obtained through emulsion polymerization. For example, a water-soluble electrolyte such as calcium chloride, magnesium sulfate, magnesium chloride, calcium acetate, sodium chloride, hydrochloric acid, acetic acid, or sulfuric acid is added to the latex to coagulate the graft copolymer particles, or the latex is frozen to separate the graft copolymer particles from an aqueous phase and coagulate them, and then, the graft copolymer particles (A) or the graft copolymer particles (B) can be separated and collected by filtering, washing, and drying the solid content. In addition, the graft copolymer particles (A) or the graft copolymer particles (B) can also be separated and collected by subjecting the latex to a treatment such as spray drying or freeze drying.

For the purpose of reducing appearance defects and/or internal foreign matter in the acrylic resin film, prior to separation and collection of the graft copolymer particles (A) or the graft copolymer particles (B), the latex of the graft copolymer particles (A) or the latex of the graft copolymer particles (B) may be filtered through a filter and/or a mesh in advance to remove substances that may cause foreign matter defects, such as environmental foreign matter and polymerization scale.

Known filters and mesh materials used for filtering liquid media can be used as the filter and the mesh. The type of filter and mesh, the opening size, filtering accuracy, filtering capacity, and the like of the filter and the mesh are selected as appropriate depending on intended use and the type, size and amount of foreign matter to be removed. The opening size and the filtering accuracy of the filter and the mesh may be, for example, at least twice as large as the average particle size of the graft copolymer particles (A) or the graft copolymer particles (B).

The content of the graft copolymer particles (A) in 100% by mass of the acrylic resin film is not particularly limited, and may be 1% by mass to 80% by mass, 5% by mass to 70% by mass, or 10% by mass to 60% by mass.

The content of the graft copolymer particles (B) in 100% by mass of the acrylic resin film is not particularly limited, and can be adjusted as appropriate within a preferred range depending on application without impairing the quality of the laminate of one or more embodiments of the present invention, and from the viewpoint of suppressing stress whitening during stretching or bending process of the acrylic resin film and clouding of the film after the film comes into contact with moisture, the content may be 0% by mass to 20% by mass, 0% by mass to 10% by mass, or 0% by mass to 5% by mass. In addition, the acrylic resin film need not contain the graft copolymer particles (B).

### Other Components

The acrylic resin film (the acrylic resin composition that constitutes the acrylic resin film) may contain thermoplastic resin that is at least partially compatible with the acrylic resin as needed, within a range such that effects of one or more embodiments of the present invention are not hindered. Examples of such thermoplastic resins include styrene-based resins, polycarbonate resins, amorphous saturated polyester resins, olefin-methacrylic acid derivative resins, olefin-acrylic acid derivative resins, polyimide resins, polylactic acid resins, and PHBH (poly(3-hydroxybutyrate-co-3-hydroxyhexanoate)) resins. Examples of the styrene-based resins include styrene-acrylonitrile resins, styrene-(meth)acrylic acid resins, styrene-maleic anhydride resins, styrene-N-substituted maleimide resins, styrene-unsubstituted maleimide resins, styrene-acrylonitrile-butadiene resins, and styrene-acrylonitrile-acrylic acid ester resins. In particular, one or more thermoplastic resins selected from the group consisting of styrene-based resins, polycarbonate resins, and polyimide resins are preferable because they have excellent compatibility with acrylic resins and may be able to improve the bending crack resistance, solvent resistance, chemical resistance, low moisture absorption, and the like of the acrylic resin film. In the present specification, (meth)acrylic acid is a general term for acrylic acid and methacrylic acid.

The acrylic resin film (the acrylic resin composition that constitutes the acrylic resin film) may also contain a conventionally known additive used in the acrylic resin films as needed, within a range such that effects of one or more embodiments of the present invention are not hindered. Such additives include antioxidants, ultraviolet absorbers (hereinafter also referred to as UVAs), light stabilizers, light diffusing agents, delustering agents, lubricants, colorants such as pigments and dyes, fibrous fillers, anti-blocking agents made of organic particles and/or inorganic particles, infrared reflectors made of metals and/or metal oxides, plasticizers, and antistatic agents. The additives are not limited to these. These additives can be used in any amount depending on the types of additives in a range such that effects of one or more embodiments of the present invention are not hindered or effects of one or more embodiments of the present invention are enhanced.

### Physical Properties of Acrylic Resin Film

A glass transition temperature (Tg) of the acrylic resin film may be 145° C. or lower, 140° C. or lower, 135° C. or lower, or 130° C. or lower. When the glass transition temperature of the acrylic resin film is 145° C. or lower, molding is possible without increasing the molding temperature, and there is an advantage that the formation of cracks during molding can be suppressed. In addition, there is no particular limitation on the lower limit of the glass transition temperature of the acrylic resin film, and from the viewpoint of preventing printing misalignment during drying of a print and improving reliability, the lower limit thereof may be, for example, 100° C. or higher. More specifically, the glass transition temperature of the acrylic resin film may be 100° C. to 145° C., 100° C. to 140° C., 100° C. to 135° C., or 100° C. to 130° C. In the present specification, the glass transition temperature of the acrylic resin film is measured using the method described in Examples.

A thickness of the acrylic resin film is not particularly limited, and for example, it may be 50 to 500 m, 75 to 350 m, 80 to 300 m, or 100 to 300 m. When the thickness of the acrylic resin film is within the above-described range, the film has sufficient stretchability and excellent handleability, and has the advantage that, when a molded body is produced, the acrylic resin film is laminated on a resin substrate, resulting in a good appearance. In the present specification, the thickness of the acrylic resin film is measured using the method described in Examples.

The pencil hardness of the acrylic resin film measured according to JIS K 5600-5-4 may be 2B or more, B or more, or HB or more, under a load of 500 g, from the viewpoint of excellent scratch resistance.

### Method for Manufacturing Acrylic Resin Film

The acrylic resin film can be manufactured using known processing methods. Specific examples of known processing methods include a melt processing method, a calendering method, a press molding method, and a solvent casting method. Examples of the melt processing method include an inflation method and a T-die extrusion method. In addition, in the solvent casting method, for example, the acrylic resin composition is dissolved and dispersed in a solvent, and the resulting dispersion (dope) is cast on a belt-like substrate to form a film shape. Then, by volatilizing the solvent from the cast dope having film-shape, an acrylic resin film can be obtained.

Among these methods, a solvent-free melt processing method is preferable, and a T-die extrusion method and a calendering method are particularly preferable. According to the melt processing method, there is little limitation on the thickness of the film to be manufactured, and films with excellent surface properties can be manufactured with high productivity, and the burden on a natural environment and a working environment due to the solvent can be reduced, and manufacturing costs can be reduced.

When the acrylic resin composition is molded into a film using a melt processing method or a solvent casting method, it is preferable to remove, through filtration using a filter or a mesh, environmental foreign matter, polymerization scale, degraded resin, and the like in the acrylic resin composition, which may cause defects in the appearance of the acrylic resin film, foreign matter within the acrylic resin film, and the like, from the viewpoint of improving the quality of the appearance of the acrylic resin film.

When a film is manufactured through melt processing, the acrylic resin composition can be filtered at any one or more opportunity in the following process: when an acrylic resin composition is melt-kneaded after raw materials such as an acrylic resin and graft copolymer particles are blended; and during a melt film formation process using a T-die. In the solvent casting method, the acrylic resin composition could be filtered before cast to form a film after the acrylic resin, the graft copolymer particles (A), the graft copolymer particles (B), and other components are mixed with a solvent.

Any known filters and meshes can be used as such filters and meshes without any particular limitations, as long as the filters and meshes have heat resistance and durability according to the melt processing conditions, and resistance to the solvent, dope, and the like used for casting.

When the acrylic resin film is manufactured through melt processing, in order to obtain a particularly high-quality acrylic resin film, it is preferable to use the filter that has a large filtering capacity and less retention of molten resin which causes occurrence of degradation and crosslinked resin that impair the quality of the film. For example, from the viewpoints of filtration efficiency and productivity, it is preferable to use a leaf disc type filter and a pleated filter.

When the acrylic resin film is manufactured using a T-die extrusion method, in order to improve the accuracy in the film thickness, for example, it is possible to use an automatic die device that measures online a film thickness distribution in the TD direction (direction perpendicular to the extrusion direction) of an extruded film and automatically adjusts a lip clearance and the like of the T-die during extrusion of the film based on the measurement. The accuracy in the thickness of acrylic resin films can be improved by applying an automatic die using an appropriate control method.

In the manufacturing of acrylic resin films, as needed, when a film is to be molded, both surfaces of the molten film can be simultaneously brought into contact with (sandwiched between) cooling rolls or cooling belts to obtain a film with better surface properties. In this case, the molten film may be simultaneously brought into contact with rolls or cooling belts maintained at a temperature that is higher than or equal to −80° C. of the glass transition temperature of the acrylic resin composition, or is higher than or equal to −70° C. of the glass transition temperature. At least one of the rolls for performing such sandwiching may be a roll having an elastic metal sleeve as disclosed in, for example, JP 2000-153547A, JP H11-235747A, and the like, and a low sandwiching pressure is applied to transfer a roll mirror surface or a specific surface shape. This makes it possible to obtain (a) a film with little residual strain and excellent surface smoothness, and/or (b) a film with an appropriate surface roughness and having excellent slipperiness of the film surface, suppressed blocking between films, and less internal strain.

In addition, it is also possible to perform uniaxial or biaxial stretching after film molding, depending on the purpose. Uniaxial or biaxial stretching can be carried out using a known stretching machine. Biaxial stretching can be carried out in a known manner, such as sequential biaxial stretching or simultaneous biaxial stretching, a method in which longitudinal stretching is performed and lateral stretching is then carried out while relaxing the film in the longitudinal direction to suppress a bowing phenomenon of the film, or the like.

Furthermore, depending on the application, one or both surfaces of the acrylic resin film may have any surface shape, such as hairlines, prisms, uneven shapes, three-dimensional decorations, a matte surface, a rough surface having certain surface roughness, and knurling on the film edges. Such a surface shape may be provided using a known method. For example, examples thereof include a method in which both surfaces of a molten film after extrusion, or a molded film provided from a winding device is sandwiched between two rolls or belts having a surface shape on at least one surface and transferred the surface shape of the rolls.

### Hard Coat Layer

The hard coat layer is formed from a cured product of a curable resin composition containing a urethane acrylate resin and a hindered amine light stabilizer having a reactive functional group. Specifically, the hard coat layer is formed by laminating a curable resin composition containing a urethane acrylate resin and a hindered amine light stabilizer having a reactive functional group on a surface of the acrylic resin film and curing the curable resin composition. The hard coat layer may be laminated on one surface or both surfaces of the acrylic resin film. From the viewpoint of not requiring a large-scale device such as a heater, being cured quickly, and being cost-effective, the curable resin composition for a hard coat layer may have active energy ray curability, and a urethane acrylate resin may have active energy ray curability.

In the laminate according to one or more embodiments of the present invention, the hard coat layer is required to have high crack elongation as well as improved surface hardness. As a result, when the laminate is subjected to secondary molding into a shape of a resin molded body, rupture or significant whitening does not occur due to stretching or bending process, or the like. However, in general, in the hard coat layer, a high surface hardness and scratch resistance are given by highly crosslinking curable resin composition and/or containing a filler having high hardness for suppressing deformation of the surface of the cured hard coat material from an external stress. Therefore, Surface hardness or scratch resistance, and deformability or stretchability, are mutually exclusive properties, and it has not been easy to accomplish the both properties in the hard coat layer.

In order to impart high stretchability during secondary molding while maintaining surface hardness of the hard coat layer, the curable resin used in the hard coat layer can be improved using, for example, methods (1) to (3) below. In the hard coat layer, for example, any of the methods (1) to (3) and the like may be used alone or in combination as appropriate. Note that, for the hard coat layer, it is possible to use, as appropriate, a commercially available curable resin composition containing a urethane acrylate resin that can impart high stretchability during secondary molding while the surface hardness of the hard coat layer is maintained.
(1) The curable resin (specifically, urethane acrylate resin) is designed such that the glass transition temperature of the curable resin is between room temperature (20° C.±5° C.) and a secondary molding temperature (e.g., approximately 110° C. to 140° C.), and the curable resin is hard at room temperature, and softens and is deformable at the secondary molding temperature. As a result, the cured product of the curable resin (hard coat layer) exhibits high surface hardness at room temperature and exhibits favorable stretchability during secondary molding.
(2) By using a combination of a plurality of curable resins having different structures, the crosslinked structure of the curable resin cured is designed to be non-uniform in terms of microstructure, with portions having a high crosslink density and portions that have a low crosslink density and significantly plastically deform, rather than being uniform. As a result, high surface hardness is achieved due to the portions having a high crosslink density in the product obtained by curing the curable resin (hard coat layer), and at the time of secondary molding, the portions having a low crosslink density deform and exhibit favorable stretchability.
(3) The curable resin is blended with a resin component having a low degree of crosslinking or a non-crosslinked resin component, and/or a resin component having a low modulus of elasticity. As a result, after the curable resin is cured, a structure is formed in which fine regions (domains) having a low degree of crosslinking or non-crosslinked fine regions, and/or fine regions (domains) having a low modulus of elasticity are dispersed in a curable resin phase having a high crosslink density, thereby imparting deformability and stretchability to the cured product of the curable resin (hard coat layer) while maintaining a certain degree of surface hardness. Examples of such resin components having a low degree of crosslinking or non-crosslinked resin components, or resin components having a low modulus of elasticity include (a) thermoplastic resins such as thermoplastic methacrylic resins, styrene acrylonitrile resins, aliphatic polycarbonate resins, aromatic polycarbonate resins, polyester resins, phenoxy resins, cellulose acylate resins, fluororesins, and polyurethane resins; (b) crosslinked or non-crosslinked soft resins such as acrylic rubber, silicone rubber, hydrogenated styrene butadiene rubber, acrylonitrile butadiene rubber, olefin-based rubber, and urethane rubber, which may have a reactive functional group as needed, and thermoplastic elastomer materials such as polyester-based, polyurethane-based, acrylic, olefin-based, styrene-based, silicone-based, and fluororesin-based thermoplastic elastomer materials; and (c) core-shell rubber particles in which a thermoplastic resin is graft-polymerized onto the surface of crosslinked rubber particles.

### Urethane Acrylate Resin

The urethane acrylate resin can be obtained by, for example, mixing a polyhydric alcohol, a polyisocyanate, and a hydroxyl group-containing (meth)acrylate, and generating a urethane bond through reaction between the isocyanate group and the hydroxyl group. In the present specification, (meth)acrylate is a general term for acrylate and methacrylate.

Furthermore, a urethane acrylate resin can also be obtained by forming a (meth)acryloyl group at an end or at a side chain through a reaction between a hydroxyl group-containing (meth)acrylate and an isocyanate group at an end or at a side chain of a polyurethane compound obtained through a reaction between a polyhydric alcohol and a polyisocyanate. In the present specification, a (meth)acryloyl group encompasses a methacryloyl group and an acryloyl group.

Various properties of the urethane acrylate resin are not particularly limited, and the molecular weight, composition, a main chain structure such as a linear or branched chain, and the number of functional groups can be adjusted as appropriate depending on the structure of the polyhydric alcohol, the type of polyisocyanate, the number of acryloyl groups or methacryloyl groups (CH₂═CH—CO— or CH₂═C(CH₃)—CO—) derived from the hydroxyl group-containing (meth)acrylate. Examples of the urethane acrylate resin further include urethane acrylate resins that are commercially available as ultraviolet-curable hard coating agents.

There is no particular limitation on the polyisocyanate, and it is sufficient that the polyisocyanate is a compound containing two or more isocyanate groups. Examples of polyisocyanate compounds include 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 4,4′diphenylmethane triisocyanate, 3,3′-dimethylphenylene diisocyanate, 4,4′biphenylene diisocyanate, 1,6-hexane diisocyanate, isophorone diisocyanate, methylene bis(4-cyclohexyl isocyanate), 2,2,4-trimethylhexamethylene diisocyanate, bis(2-isocyanate ethyl) fumarate, 6-isopropyl-1,3-phenyl diisocyanate, 4-diphenylpropane diisocyanate, tolidine diisocyanate, hydrogenated diphenylmethane diisocyanate, hydrogenated xylylene diisocyanate, tetramethylxylylene diisocyanate, 2,5-bis(isocyanate methyl)-bicyclo[2.2.1]heptane, 2,6-bis(isocyanate methyl)bicyclo[2.2.1]heptane, trimethylolpropane adducts of triethylene diisocyanate, isocyanurates of triethylene diisocyanate, oligomers of diphenylmethane-4,4′-diisocyanate, biurets of hexamethylene diisocyanate, isocyanurates of hexamethylene diisocyanate, uretdiones of hexamethylene diisocyanate, and isocyanurates of isophorone diisocyanate. In particular, polyisocyanate compounds that do not contain an aromatic skeleton and have a saturated aliphatic skeleton or an alicyclic skeleton are preferable because they provide a structure with superior weather resistance. Examples of such polyisocyanate compounds include 1,6-hexane diisocyanate, isophorone diisocyanate, methylene bis(4-cyclohexyl isocyanate), 2,2,4-trimethylhexamethylene diisocyanate, hydrogenated diphenylmethane diisocyanate, hydrogenated xylylene diisocyanate, 2,5-bis(isocyanatemethyl)-bicyclo[2.2.1]heptane, and 2,6-bis(isocyanatemethyl)-bicyclo[2.2.1]heptane. In addition, these polyisocyanates can be used alone or in combination of two or more.

Specific examples of polyhydric alcohols include ethylene glycol, 1,3-propanediol, 1,3-butanediol, 1,4-butanediol, 1,5-pentanediol, 1,6-hexanediol, 1,7-heptanediol, 1,8-octanediol, 1,9-nonanediol, 1,10-decanediol, 3-methyl-1,5-pentanediol, neopentyl glycol, 2-methyl-1,8-octanediol, cyclohexanediol, 1,4-cyclohexanedimethanol, glycerol, pentaerythritol, dipentaerythritol, polycaprolactone diol, polyethylene glycol, polypropylene glycol, polytetramethylene glycol, polyester diol, polycarbonate diol, polyurethane diol, bisphenol compounds, biphenol compounds, norbornadiol, dicyclopentanediol, and adamantanediol. In particular, polyhydric alcohols that do not contain an aromatic skeleton and have a saturated aliphatic skeleton or an alicyclic skeleton are preferable because they provide a structure with superior weather resistance. These polyhydric alcohols may be used alone or in combination of two or more.

The hydroxyl group-containing (meth)acrylate is not particularly limited, and for example, it is possible to add 2-hydroxyethyl acrylate and 2-hydroxyethyl methacrylate as well as (a) compounds having at least one hydroxyl group and an ethylenically unsaturated bond, such as 2-hydroxypropyl (meth)acrylate, 4-hydroxybutyl acrylate, polyethylene glycol mono(meth)acrylate, polypropylene glycol mono(meth)acrylate, trimethylolpropane mono(meth)acrylate, trimethylolpropane di(meth)acrylate, allyl alcohol, ethylene glycol allyl ether, glycerin (mono-, di-)allyl ether, N-methylol(meth)acrylamide, and like, or (b) mixtures thereof, as needed.

In order to promote the reaction between the isocyanate group of the isocyanate component and the hydroxyl group, an organotin-based urethanization catalyst is used. It is sufficient that the organotin-based urethanization catalyst is any that is generally used in urethanization reactions, and examples thereof include dibutyltin dilaurate, dibutyltin diacetate, dibutyltin dialkyl malate, tin stearate, and tin octoate.

In one or more embodiments of the present invention, a curable resin composition containing a commercially available urethane acrylate resin may be used as at least a part of the curable resin composition for a hard coat layer. Examples of such commercially available products include product name “Z-607-27L” manufactured by Aica Kogyo Company, Limited, product name “BEAMSET 1200W” manufactured by Arakawa Chemical Industries, Ltd., product name “Acrit 8UX-116A” manufactured by Taisei Fine Chemical Co., Ltd., product name “NXD-004AP” manufactured by Nippon Kako Toryo Co., Ltd., product name “P-5820TAH-1” and “P-5820TA-20J” manufactured by Daido Chemical Corporation, and product name “Lioduras MOL7200” manufactured by Toyochem Co., Ltd. Curable resin compositions containing these commercially available urethane acrylate resins have high elongation even after curing, and thus the crack elongation of a laminate at 120° C. can be further increased by using such products.

### Light Stabilizer

The curable resin composition for a hard coat layer contains a light stabilizer. Since the curable resin composition for a hard coat layer contains a light stabilizer, the stability of the hard coat layer against degradation by ultraviolet light and visible light irradiation is improved, and weather degradation such as surface cracking and peeling of the molded body covered with the laminate including the hard coat layer is suppressed at the locations or in the applications exposed to sunlight at outdoors or indoors.

The curable resin composition for a hard coat layer contains, as a light stabilizer, a hindered amine light stabilizer having at least a reactive functional group (also referred to as “reactive HALS” hereinafter). In the reactive HALS, the reactive functional group need only be reactive with the urethane acrylate resin, and examples thereof include a functional group having an ethylenic double bond. More specifically, the reactive functional group may include one or more selected from the group consisting of a methacryloyl group, an acryloyl group, a vinyl group, an allyl group, and the like, or may include one or more selected from the group consisting of a methacryloyl group and an acryloyl group. In addition, a substituent on a nitrogen atom of an amine functional group may be hydrogen or may be a substituent such as an alkyl group such as a methyl group, an ethyl group, or a propyl group, a phenyl group, a benzyl group, an alkyloxy group, an acyl group, or an acyloxy group. Since the hindered amine light stabilizer has a reactive functional group, when the urethane acrylate resin is to be cured, the hindered amine light stabilizer molecules react with the urethane acrylate resin and are introduced in a chemically bonded state into the cured product that forms the hard coat layer. This suppresses the hindered amine light stabilizer from migration or bleeding out from the surface of the hard coat layer, and thus makes it possible to suppress deterioration of the weather resistance of the hard coat layer for a longer period of time.

Examples of reactive HALSs include, but are not limited to, 4-(meth)acryloyloxy-2,2,6,6-tetramethylpiperidine, 4-(meth)acryloylamino-2,2,6,6-tetramethylpiperidine, 4-(meth)acryloyloxy-1,2,2,6,6-pentamethylpiperidine, 4-(meth)acryloylamino-1,2,2,6,6-pentamethylpiperidine, 4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine, 1-(meth)acryloyl-4-(meth)acryloylamino-2,2,6,6-tetramethlpiperidine, 1-(meth)acryloyl-4-cyano-4-(meth)acryloylamino-2,2,6,6-tetramethylpiperidine, and 1-crotonoyl-4-crotoyloxy-2,2,6,6-tetramethylpiperidine. These reactive HALSs may be used alone or in combination of two or more.

For example, commercially available products such as 1,2,2,6,6-pentamethyl-4-piperinyl methacrylate (product name “ADK STAB LA-82” manufactured by ADEKA Corporation or product name “FA-711MM” manufactured by Hitachi Chemical Co., Ltd.), 2,2,6,6-tetramethyl-piperidinyl methacrylate (also referred to as 4-methacryloyloxy-2,2,6,6-tetramethylpiperidine, product name “ADK STAB LA-87” manufactured by ADEKA Corporation, or product name “FA-712HM” manufactured by Hitachi Chemical Co., Ltd.) may be used as the reactive HALS.

The curable resin composition for a hard coat layer may contain a reactive HALS in an amount of 1 to 10 parts by mass, 1.5 to 6 parts by mass, or 2 to 4 parts by mass, with respect to 100 parts by mass of the urethane acrylate resin. The long-term weather resistance is improved due to the curable resin composition for a hard coat layer containing a reactive HALS in an amount of 1 part by mass or more. In addition, when the amount of the reactive HALS is 10 parts by mass or less, weather resistance can be improved without impairing the quality of the hard coat layer.

The curable resin composition for a hard coat layer may contain, in addition to the reactive HALS, other light stabilizers such as hindered amine light stabilizers (also referred to as “HALS” hereinafter) that do not have a reactive functional group as needed. Examples of HALSs include bis(1,2,2,6,6-pentamethyl-4-piperidyl)sebacate, bis(1,2,2,6,6-pentamethyl-4-piperidinyl)sebacate, methyl(1,2,2,6,6-pentamethyl-4-piperidinyl)sebacate, and 2,4-bis[N-butyl-N-(1-cyclohexyloxy-2,2,6,6-tetramethylpiperidin-4-yl)amino]-6-(2-hydroxyethylamine)-1,3,5-triazine. In this case, from the viewpoint of further improving weather resistance without causing bleed-out or curing inhibition during curing of the hard coat layer, the curable resin composition for a hard coat layer may contain the light stabilizer in a total amount of 1 to 10 parts by mass, 1.5 to 6 parts by mass, or 2 to 4 parts by mass, with respect to 100 parts by mass of the urethane acrylate resin.

### Other Components

The curable resin composition for a hard coat layer may contain other components, in addition to the urethane acrylate resin and the light stabilizer. As other components, for example, monomers, oligomers, and resins that have a radical reactive functional group, such as (meth)acrylate-based compounds, epoxy acrylate-based monomers, polyester acrylates, and polyacryl acrylates, or mixtures thereof may be used in combination. Further, the urethane acrylate resin may be used in combination with, for example, (a) a hydrolysis condensate of a di- to tetra-functional silane compound, and/or (b) a monomer, an oligomer, and a resin that have cationically curable and/or anionically curable functional groups such as an epoxy group and an oxetane group, or a composition containing a mixture thereof. These other components may be used alone or in combination of two or more.

There is no particular limitation on the (meth)acrylate-based compound, as long as it has at least one or more (meth)acryloyl groups. Specific examples thereof include alicyclic (meth)acrylates such as alkyl (meth)acrylates, aryl (meth)acrylates, phenoxyethyl (meth)acrylates, and isobornyl (meth)acrylates; and polyfunctional (meth)acrylates such as polyalkylene glycol di(meth)acrylates, dipentaerythritol hexa(meth)acrylates, dipentaerythritol penta(meth)acrylates, dipentaerythritol tetra(meth)acrylates, dipentaerythritol tri(meth)acrylates, pentaerythritol tetra(meth)acrylates, pentaerythritol tri(meth)acrylates, trimethylolpropane tri(meth)acrylates, trimethylolethane tri(meth)acrylates, hexanediol di(meth)acrylates, and diethylene glycol di(meth)acrylates. These may be used alone or in combination of two or more. Examples of (meth)acrylate-based compounds include (meth)acrylate-based compounds that are commercially available as ultraviolet-curable hard coating agents.

There is no particular limitation on the epoxy acrylate-based monomers. Specifically, examples thereof include glycidyl (meth)acrylate, β-methylglycidyl (meth)acrylate, 3,4-epoxycyclohexylmethyl (meth)acrylate, and vinylcyclohexene monoxide (i.e., 1,2-epoxy-4-vinylcyclohexane).

A known method can be applied as a method for curing a resin layer (curable resin composition) when a hard coat layer is formed. A method for irradiating the resin layer with active energy rays represented by ultraviolet rays or electron beam rays is preferable as a curing method. When the resin layer is cured by irradiation with ultraviolet rays, a photopolymerization initiator is used.

Specific examples of the photopolymerization initiator include acetophenone, benzophenone, benzoyl methyl ether, benzoyl ethyl ether, benzoin isopropyl ether, benzoin isobutyl ether, dibenzyl, 1-hydroxy-cyclohexyl-phenyl-ketone, 2,2-dimethoxy-2-phenylacetophenone, tetramethylthiuram monosulfide, tetramethylthiuram disulfide, thioxanthone, 2-chlorothioxanthone, 2-methylthioxanthone, and 2-methyl-1-[4-(methylthio)phenyl]-2-morpholinopropan-1-one compounds. In particular, from the viewpoint of high compatibility with a urethane acrylate resin, 1-hydroxy-cyclohexyl-phenyl-ketone is preferable.

The hard coat layer can be formed by applying a curable composition to one or both surfaces of an acrylic resin film and curing a resin layer (coating film) made of the curable resin composition. In this case, the curable composition may contain various known leveling agents and antifouling agents for the purpose of improving the coatability, scratch resistance after curing, antifouling properties, smoothness, and the like. It is possible to use as the leveling agent or the antifouling agent, leveling agents and antifouling agents made of various compounds such as fluorine-based, acrylic, and silicone-based compounds, and adducts or mixtures thereof. These leveling agents and antifouling agents may contain a functional group that is reactive with a urethane acrylate resin. The blend amount of the leveling agent or the antifouling agent is not particularly limited, and may be, for example, 0.03 to 3.0 parts by mass with respect to 100 parts by mass of the curable composition.

When the hard coat layer is formed by applying the curable composition to one or both surfaces of an acrylic resin film and curing the resulting coating film, it is possible to add, as needed, various additives such as an ultraviolet absorber, an antifoaming agent, an antioxidant, a light diffusing agent, a matting agent, an antifouling agent, a lubricant, colorants such as pigments and dyes, organic particles, inorganic particles, and antistatic agents. The additives are not limited to these.

In addition, the curable resin composition for a hard coat layer may contain inorganic particles in a range such that effects of one or more embodiments of the present invention are not hindered. There is no particular limitation on the inorganic particles, and examples thereof include silica, alumina, titanium oxide, zinc oxide, zirconia, graphene, nanocarbon, carbon black, nanodiamond, mica, barium titanate, boron nitride, metallic silver, and metallic copper. These particles may be used without performing surface treatment, or may be surface-treated in advance using a known method in order to control a dispersion state and maintain favorable stretchability, and the affinity with the hard coat layer may be controlled as appropriate.

In addition, from the viewpoint of enhancing an antiglare property of the laminate, the curable resin composition for a hard coat layer may contain particles in a range such that effects of one or more embodiments of the present invention are not hindered. With regard to particles to be blended in the hard coat layer for the purpose of imparting an antiglare property and the like, for example, in order to obtain a balance of various properties such as a desired antiglare property, clarity of a transmitted image, glare, jet black surface, surface hardness, slipperiness, and an antistatic property, the particle material, the amount of particles, the type of particle dispersion solvent, a particle size, a dispersed particle size, the thickness of a hard coat layer, a difference in refractive index with respect to the hard coat substrate, the affinity and reactivity of the particle surface with the hard coat substrate or the solvent, and the like can be adjusted as appropriate within known technical ranges in which an effect of one or more embodiments of the present invention is not hindered.

The material of particles to be blended in the hard coat layer is not particularly limited as long as the antiglare property of the laminate can be enhanced in a range such that effects of one or more embodiments of the present invention is not hindered, and for example, inorganic particles and/or organic particles can be used. Examples of inorganic particles include silica, alumina, glass beads, glass flakes, mica, clay, titanium oxide, zinc oxide, zirconia, and metal particles. Examples of organic particles include crosslinked organic resin particles having one or more main components selected from the group consisting of alkyl (meth)acrylate units, aromatic vinyl units, and organic functional group-substituted siloxane units, and core-shell multilayer resin particles. From the viewpoint of ease of availability and ease of designing an antiglare property according to applications, particles may be one or more selected from the group consisting of inorganic oxide particles (e.g., silica, alumina, titanium oxide, zinc oxide, zirconia, and the like) and crosslinked organic resin particles (e.g., crosslinked silicone resin, crosslinked acrylic resin, crosslinked aromatic vinyl resin, and the like), or one or more selected from the group consisting of silica, alumina, zirconia, and crosslinked organic resin particles. In addition, from the viewpoint of the balance of physical properties such as an antiglare property, dispersibility, and surface hardness, the particles may be one or more selected from the group consisting of silica, alumina, and crosslinked organic resin particles. Also, from the viewpoint of controlling dispersibility, these particles may be subjected to surface treatment and/or graft polymerization treatment, or the like, using a known method such as the use of a silane coupling agent or reactive monomer that may have a reactive substituent, plasma treatment, corona treatment, or the like. At least some of the particles may have reactive functional groups on surfaces of the particles that are reactive with the urethane acrylate resin, because interfacial adhesion between the particles and the hard coat layer is improved, and the dispersibility of the particles, and the cracking and/or whitening during stretching can be improved. Examples of reactive functional groups that are reactive with the urethane acrylate resin include (a) radically reactive functional groups such as a vinyl group and a (meth)acryloyl group, (b) ionic functional groups such as an epoxy group, an oxetane group, a hydroxyl group, a carboxyl group, a mercapto group, isocyanyl group, a hydroxyl group, and an amino group, and (c) moisture-curable functional groups such as a silyl group and an alkoxysilyl group.

In the hard coat layer, “particles” may be dispersed in the state of primary particles, or may be dispersed in a state where a plurality of particles are aggregated, depending on the size of the primary particles. The size of regions (dispersed domains) in which these particles or their aggregates are distributed is defined as an “average dispersed particle size”. When the primary particle size is large, the average dispersed particle size may be the same as the primary (basic) particle size.

The average dispersed particle size of the particles (e.g., silica particles) is not particularly limited as long as effects of one or more embodiments of the present invention are obtained, and may be, for example, 0.1 to 50.0 μm, 0.2 to 25.0 μm, or 0.5 to 10 μm, or the like. In the present specification, a photograph of a cross section of the laminate with a size of 1200 nm×800 nm is observed using an electron microscope (H7650 manufactured by Hitachi High-Tech Corporation) at a magnification of 200,000, and an arithmetic mean value of the particle sizes of 10 dispersed domains of the particles in the hard coat layer is calculated, and the obtained value is regarded as the average dispersed particle size of the particles in the hard coat layer.

The content of the particles in the hard coat layer is not particularly limited as long as the antiglare property of the laminate can be enhanced in a range such that effects of one or more embodiments of the present invention are not hindered, and for example, the content of the particles may be, for example, 0.1% by mass to 30.0% by mass, 0.5% by mass to 20.0% by mass, or 1.0% by mass to 15.0% by mass, or the like.

In order to impart appropriate coatability to the curable composition, an organic solvent is usually blended therein. The organic solvent is not particularly limited as long as desired coatability can be imparted to the curable composition, and a hard coat layer having desired thickness and performance can be formed. The boiling point of the organic solvent may be 50° C. to 150° C. in terms of coatability and a drying property of the resin layer (coating film) to be formed.

Specific examples of the organic solvents include saturated hydrocarbons such as hexane; aromatic hydrocarbons such as toluene and xylene; halogenated hydrocarbons such as chloroform and methylene chloride; alcohols such as methanol, ethanol, isopropyl alcohol, and butanol; esters such as methyl acetate, ethyl acetate, and butyl acetate; ketones such as acetone, methyl ethyl ketone, methyl isobutyl ketone, and cyclohexanone; ethers such as tetrahydrofuran, dioxane, propylene glycol monoethyl ether, methyl cellosolve, and ethyl cellosolve; and amides such as N-methylpyrrolidone and dimethylformamide. These organic solvents can be used alone or in combination of two or more.

When the curable composition is applied to one or both surfaces of the acrylic resin film, any method can be used as a coating method without any particular limitation. Examples of the coating method include reverse coating, gravure coating, bar coating, die coating, spray coating, kiss coating, wire bar coating, and curtain coating. These coating methods may be used alone or in combination of two or more.

The above-described curable composition for a hard coat layer is applied to one or both surfaces of an acrylic resin film to form a resin layer (coating film), and then the organic solvent is removed from the coating film through drying, and the resin layer is cured by active energy rays, such as ultraviolet irradiation, thereby forming a hard coat layer.

The drying temperature for removing the organic solvent from the resin layer after coating may be 60° C. to 120° C., or 70° C. to 100° C. If the drying temperature is excessively low, the organic solvent may remain in the resin layer (coating film). In addition, if the drying temperature is excessively high, the flatness of the laminate (hard coat layer) may be impaired due to thermal deformation of the acrylic resin film.

The wavelength of the ultraviolet rays used for irradiation when the resin layer (coating film) is cured may be in a range of 200 to 400 nm. The integrated light quantity of the ultraviolet (UV) irradiation may be, for example, 150 to 700 mJ/cm², 180 to 500 mJ/cm², or 200 to 400 mJ/cm². When the integrated light quantity of the UV irradiation is within the above-mentioned range, it is possible to obtain an appropriate hardness of the hard coat layer while ensuring moldability. For example, an irradiation device equipped with either (a) a lamp light source such as a high-pressure mercury lamp, a low-pressure mercury lamp, a metal halide lamp, an electrodeless lamp, or an excimer lamp, and/or (b) a pulsed or continuous laser light source such as an argon ion laser or a helium neon laser can be used as an irradiation device for ultraviolet exposure light.

Furthermore, for the purpose of further improving the surface hardness, chemical resistance, weather resistance, and the like of a resin molded body having a laminate of one or more embodiments of the present invention placed on its surface, an operation for irradiating with active energy rays such as ultraviolet rays may carry out, after the laminate is secondary molded through vacuum and/or pressure molding, or on at least a portion of the surface of resin molded body having the laminate placed on its surface.

### Laminate

In one or more embodiments of the present invention, as shown in the FIGURE, a laminate 1 includes the acrylic resin film 2 and the hard coat layer 3 laminated on one surface of the acrylic resin film 2. Although not shown, the hard coat layer may be laminated on both surfaces of the acrylic resin film. In addition, the laminate may include another functional layer laminated between the acrylic resin film and the hard coat layer and/or on the hard coat layer, as needed, in a range such that an effect of one or more embodiments of the present invention is not hindered. Furthermore, the laminate may have another functional layer laminated on the acrylic resin film surface opposite to the hard coat layer

There is no particular limitation on the other functional layer, and a wide variety of conventionally known layers can be used. Examples of the other functional layer include a low refractive index layer, a primer layer, a high refractive index layer, an adhesive layer, an antiglare layer, an antifouling layer, a fingerprint resistant layer, a scratch resistant layer, an antistatic layer, an ultraviolet shielding layer, an infrared shielding layer, a surface uneven layer, a light diffusing layer, a matting layer, a polarizing layer, a colored layer, a design layer, a printed layer, an embossed layer, a conductive layer, a gas barrier layer, and a gas absorbing layer. The laminate may also include two or more other functional layers used in combination. Further, one functional layer may have two or more functions.

The laminate has a crack elongation of 100% or more at 120° C. This makes it possible to suppress the occurrence of defects such as cracks and whitening in the laminate, when the laminate is laminated on a thermoplastic resin substrate and the thermoplastic resin substrate is covered with the laminate, particularly when the laminate is shaped through vacuum molding under heating or compressed air molding, or laminated and molded onto a substrate, or when, as needed, the shaped laminate is placed on the surface of a mold and then a molded body is obtained through insert injection molding, thereby providing good secondary moldability. The crack elongation of the laminate at 120° C. may be 110% or more, 120% or more, 130% or more, or 140% or more. In the present specification, the crack elongation of the laminate at 120° C. can be measured using the method described in Examples.

From the viewpoint of excellent long-term weather resistance, no cracks may be formed on the surface of the hard coat layer of the laminate even when the laminate is subjected to the accelerated weathering test, in which the laminate is placed such that the hard coat layer side is located on the light source side, and a xenon lamp is used as a light source, and 1000 test cycles (2000 hours in total) are performed under the condition of irradiance of 180 W/m² (300 to 400 nm), where one test cycle for 120 minutes in total includes a step 1 with an exposure time of 102 minutes, a black panel at 60° C.±3° C., a relative humidity of 65%±5%, and no rain, and a step 2 with an exposure time of 18 minutes, a chamber temperature of 38° C.±3° C., a humidity of 95%±5%, and with rain. In addition, a color difference ΔE of the laminate after the accelerated weathering test relative to the laminate before the accelerated weathering test may be 0.5 or less, or 0.3 or less. In particular, even when direct sunlight is simulated, specifically, when a filter is configured such that quartz glass is used on the inner side and polysilicate #275 is used on the outer side, and the above accelerated weathering test is performed for 2000 hours, no cracks may be formed on the surface of the hard coat layer of the laminate, and a color difference ΔE of the laminate after the accelerated weathering test to the laminate before the accelerated weathering test may be 0.5 or less, or 0.3 or less.

From the viewpoint of transparency, the laminate may have a haze (Hz) of 2.0% or less, 1.5% or less, 1.0% or less, 0.8% or less, or 0.4% or less. However, this does not necessarily apply when components such as matting agent or antiglare agent or like are introduced into an acrylic resin film substrate and/or a hard coat layer based on the quality requirements such as appearance. In the present specification, the haze can be measured using the method described in Examples.

From the viewpoint of excellent surface hardness and enhancing the scratch resistance of a resin molded body obtained using the laminate, the pencil hardness of the laminate on the hard coat layer side under a load of 500 g may be B or more, HB or more, F or more, or H or more.

From the viewpoint of excellent chemical resistance, the appearance of the laminate may have no visible change when about 0.02 mL of isopropyl alcohol is dropped onto the surface of the hard coat layer and is left at 23° C. for 6 hours. In addition, from the viewpoint of excellent chemical resistance, the appearance of the laminate may have no visible change when about 0.02 mL of acetone is dropped onto the surface of the hard coat layer and is left at 23° C. for 6 hours.

From the viewpoint of suppressing whitening of edges of the laminate trimmed after molding, the laminate may have a Δhaze (ΔHz) of 3% or less when the laminate is stretched by 20% at room temperature, 2% or less, or 1.5% or less. In the present specification, the ΔHz of the laminate stretched by 20% at room temperature can be measured using the method described in Examples.

From the viewpoint of suppressing whitening during molding, the ΔHz of the laminate stretched by 80% at 120° C. may be 3% or less, 2% or less, 1% or less, 0.8% or less, or 0.4% or less. In the present specification, the ΔHz of the laminate stretched by 80% at 120° C. can be measured using the method described in Examples.

### Resin Molded Body

The resin molded body includes a thermoplastic resin substrate and the laminate, and at least a portion of the thermoplastic resin substrate is covered with the laminate disposed such that an acrylic resin film is located on the thermoplastic resin substrate side. Since the laminate has a high crack elongation at 120° C., it is possible to suitably obtain a resin molded body having a three-dimensional shape by covering, with the laminate, a thermoplastic resin substrate having at least a portion having a non-planar curved shape and/or a three-dimensional shape. In resin molded bodies having various shapes, the laminate covers the thermoplastic resin substrate and thus can provide various functionalities such as long-term weather resistance, scratch resistance, and chemical resistance to the resin molded bodies.

The thermoplastic resin substrate may be constituted by, for example, a polycarbonate resin having a bisphenol-based skeleton, a fluorene-based skeleton, or an isosorbide-based skeleton, an acrylic resin, a styrene-based resin (such as AS resin, ABS resin, MAS resin, styrene-maleimide-based resin, and styrene-maleic anhydride resin), a saturated polyester resin, a polyvinyl chloride, a polyarylate resin, a PPS-based resin, a POM-based resin, a polyamide resin, a polylactic resin, a cellulose acrylate-based resin, a polyolefin-based resin, or the like. In particular, one or more resins selected from the group consisting of the polycarbonate resin, the acrylic resin, the styrene-based resin, and the amorphous polyolefin-based resin are preferable because these resins have excellent transparency, and polycarbonate resins and/or acrylic resins are more preferable because these resins have good adhesion to the laminate, and polycarbonate resins are even more preferable from the viewpoint of high rigidity, high heat resistance, and high impact resistance.

The resin molded body can be used as, for example, an automobile interior member, an automobile exterior member, an optical member, a home appliance member, an exterior member for a building, and the like. Since the laminate has excellent long-term weather resistance, a resin molded body obtained using the laminate can be suitably used as an automobile exterior member, an exterior member for a building, or the like. Examples of automobile exterior members include, but are not particularly limited to, door mirrors, windows, headlamp covers, tail lamp covers, windshield parts, weather strips, bumpers, bumper guards, side mudguards, body panels, spoilers, front rills, strut mounts, wheel caps, center pillars, center ornaments, side moldings, door moldings, and window moldings. Examples of exterior members for buildings include exterior wall members such as siding, fences, roofs, gates, and barge boards.

A method for manufacturing the resin molded body is not particularly limited as long as at least a portion of the thermoplastic resin substrate can be covered with the laminate disposed such that the acrylic resin film is located on the thermoplastic resin substrate side. In addition, in the laminate, the above-described other functional layers may be formed as appropriate prior to the laminate being laminated on a substrate. A resin molded body in which the laminate is placed on its surface can be manufactured using such the laminate through, for example, insert injection molding. In addition, before insert injection molding, preparatory molding may be performed on the laminate as needed using a method such as vacuum molding, pressure molding, or compression molding. Alternatively, it is also possible to perform so-called three-dimensional laminate molding, in which the laminate is applied with reduced pressure and/or increased pressure under heat, then the laminate is placed on the surface of the thermoplastic resin substrate having at least a portion having a non-flat three-dimensional shape (curved shape) under reduced pressure and/or increased pressure to form the laminated resin molded body. Furthermore, the resin molded body may be produced by laminating the laminate on the surface of the thermoplastic resin substrate by hand while the laminate is heated and stretched by hand as appropriate.

### EXAMPLES

Hereinafter, one or more embodiments of the present invention will be described in detail based on examples. The present invention is not limited to these examples. In the following, unless otherwise specified, “parts” means “parts by mass” and “%” means “% by mass”.

Measurement methods and evaluation methods used in the examples and comparative examples will be described below.

### Glass Transition Temperature

A differential scanning calorimeter (DSC, model number “SSC-5200” manufactured by Seiko Instruments Inc.) was used. A sample was once heated to 200° C. at a rate of 25° C./min, held at 200° C. for 10 minutes, and then pre-adjusted by lowering the temperature to 50° C. at a rate of 25° C./min. The DSC measurement was then performed while the sample was heated to 200° C. at a temperature increase rate of 10° C./min. A differential value was determined from the obtained DSC curve (SSDC), and the glass transition temperature was calculated from the maximum point.

### Tensile Elongation at Break at 120° C.

The acrylic resin film was cut along a machine direction (MD) during extrusion molding to prepare a sample with 10 mm (width)×100 mm (length). A tensile test was performed using a Tensilon tension testing machine (model number “AG-2000D” manufactured by Shimadzu Corporation) equipped with a high-temperature chamber set to 120° C., under the conditions that a pre-heating time before test was 2 minutes, a chuck distance was 40 mm, and a tensile speed was 200 mm/min. The elongation when the test piece ruptured was measured, and the average value of test results obtained by measuring the elongation of three samples was regarded as the rupture elongation at 120° C.

### Crack Elongation at 120° C.

The laminate was cut to prepare a sample with 10 mm (width)×100 mm (length). A tensile test was performed using a Tensilon tension testing machine (model number “AG-2000D” manufactured by Shimadzu Corporation) equipped with a high-temperature chamber set to 120° C., under the conditions that a pre-heating time before test was 2 minutes, a chuck distance was 40 mm, and a tensile speed was 200 mm/min. The elongation when a crack formed in the hard coat layer was measured, and the average value of test results obtained by measuring the elongation of three samples was regarded as the crack elongation at 120° C.

### Thickness

The thickness of the acrylic resin film was measured using a PEACOCK dial gauge No. 25 (manufactured by Ozaki MFG. Co., Ltd.).

The thickness of the hard coat layer was measured using an F20 film thickness measurement system (manufactured by Filmetrics Inc.). The surface opposite to the hard coat layer was painted black with a felt tip pen, and measurement was performed with the refractive index of the acrylic resin film being set to 1.49, and the refractive index of the hard coat layer being set to 1.50.

### Haze

The haze was measured using a haze meter NDH4000 (manufactured by Nippon Denshoku Industries Co., Ltd.) according to ISO 14782.

ΔHz after Stretched by 80% at 120° C.

The laminate was cut to prepare a sample with 10 mm (width)×100 mm (length). A tensile test was performed using a Tensilon tension testing machine (model number “AG-2000D” manufactured by Shimadzu Corporation) equipped with a high-temperature chamber set to 120° C., under the conditions that a pre-heating time was 2 minutes, a chuck distance was 40 mm, and a tensile speed was 200 mm/min. The haze of the sample before the tensile test was measured and used as the haze of the laminate before stretched, and the haze of the sample after stretched by 80% was measured and used as the haze of the laminate after stretched by 80% at 120° C. A difference between the haze of the laminate after stretched by 80% at 120° C. and the haze of the laminate before stretched was defined as ΔHz after stretched by 80% at 120° C.

ΔHz of the laminate after stretched by 80% at 120° C.=the haze of the laminate after stretched by 80% at 120° C.−the haze of the laminate before stretched

ΔHz after Stretched by 20% at Room Temperature

The laminate was cut to prepare a sample with 10 mm (width)×100 mm (length). A tensile test was performed using the tensile testing machine (model number “AG-2000D” manufactured by Shimadzu Corporation) under the conditions that the temperature was 23° C., a chuck distance was 40 mm and a tensile speed was 200 mm/min to stretch the sample by 20%. The sample stretched by 20% was left at 23° C. for 12 hours, the haze was then measured and defined as the haze of the laminate after stretched by 20% at room temperature. The haze of the sample measured before the tensile test was used as the haze of the laminate before stretched. A difference between the haze of the laminate after stretched by 20% at room temperature and the haze of the laminate before stretched was defined as ΔHz after stretched by 20% at room temperature.

ΔHz of the laminate after stretched by 20% at room temperature=the haze of the laminate after stretched by 20% at room temperature−the haze of the laminate before stretched

### Pencil Hardness

Pencil hardness was measured under a load of 500 g according to JIS K 5600-5-4: 1999.

### Accelerated Weathering Test

A super xenon weather meter (SX2D-75 manufactured by Suga Test Instruments Co., Ltd.) was used. The filter was configured such that quartz glass was used on the inner side and polysilicate #275 was used on the outer side, and direct sunlight was simulated. An accelerated weathering test was performed, in which a laminate sample (40 mm×50 mm) was placed such that the hard coat layer side was located on the light source side, and 1000 test cycles (2000 hours) were performed, where one test cycle (120 minutes in total) included a step 1 below and a step 2 below.

Step 1: The exposure time was 102 minutes, the irradiance was 180 W/m² (300 to 400 nm), the black panel temperature was 60° C.±3° C., the relative humidity was 65% 5%, and no rain

Step 2: The exposure time was 18 minutes, the irradiance was 180 W/m² (300 to 400 nm), the chamber temperature was 38° C.±3° C., the relative humidity was 95%±5%, and with rain

After the accelerated weathering test, the surface of the hard coat layer of the sample was visually observed to check the presence or absence of cracks. When no cracks were observed, it was determined that the sample had favorable long-term weather resistance.

The color difference of the laminate after the weathering test relative to the laminate before the weathering test was determined. The color difference (ΔE) was measured using a spectrophotometer SE7700 (manufactured by Nippon Denshoku Industries Co., Ltd.) under the following conditions.

Mode: transmittance, light source: D65, field of view: 2°, measurement diameter: 28 mm

### Chemical Resistance Test

A laminate sample cut into a 5 cm×5 cm square was placed on a horizontal surface such that the hard coat layer side was located on the upper side and one drop (approximately 0.02 mL) of isopropyl alcohol (also referred to as IPA hereinafter) taken with a dropper was poured thereon. The sample was then left at room temperature (23° C.) for 6 hours, the surface thereof was then observed, and the chemical resistance was evaluated according to the following criteria.
Good: No change in appearance
Slightly poor: Contour remains
Poor: Appearance appears to have melted

### Coating Material 1

Methyl ethyl ketone (MEK) was blended in a highly stretchable curable resin composition (containing a urethane acrylate resin, product name “P5820TA-20J” manufactured by Daido Chemical Corporation, solid content was 25%) such that the solid content was 23%.

### Coating Material 2

Methyl ethyl ketone (MEK) was blended in a curable resin composition having low stretchability (containing a urethane acrylate resin, product name “ENS-102” manufactured by DIC Corporation, solid content was 99%) such that the solid content was 23%.

### Example 1

### Production of Acrylic Resin Film

Multilayer particles (C4) having an average particle size of 85 nm produced using a method similar to that of Manufacturing Example 4 in JP 2020-147653A were used as graft copolymer particles (A-1), and poly(methyl methacrylate) (product name “SUMIPEX (registered trademark) MG” manufactured by Sumitomo Chemical Company, Limited) was used as acrylic resin (D-1). 100 parts of a resin mixture 1 containing the graft copolymer particles (A-1) in an amount of 38% and acrylic resin (D-1) in an amount of 62%, 0.3 parts of a hindered phenol-based antioxidant (product name “Irganox1010” manufactured by BASF SE), and 1.5 parts of an ultraviolet absorber (benzotriazole-based ultraviolet absorber, product name “ADK STAB LA-31” manufactured by ADEKA Corporation) were mixed using a Henschel mixer. Then, the resulting mixture was melt-kneaded at a screw rotation speed of 150 rpm and a discharge amount of 180 kg/hr using a vented co-rotating twin-screw extruder (model number “TEM58” manufactured by Toshiba Machine Co., Ltd., L/D=41.7) with an extrusion diameter of 58 mm and a cylinder temperature adjusted to 190° C. to 250° C., and taken up in the form of strands, cooled in a water tank, and then cut into pellets using a pelletizer. The obtained pellets were melt-kneaded using a single-screw extruder with a T-die and an extrusion diameter of 90 mm at a cylinder setting temperature of 180° C. to 240° C. and a discharge rate of 150 kg/hr, and extruded from the T-die at a die temperature of 240° C. Both surfaces of the resultant were brought into contact with a metal casting roll whose temperature was adjusted to 90° C. and a touch roll equipped with an elastic metal sleeve adjusted to 60° C., and the resultant was cooled and solidified while forming a film and wound up to obtain an acrylic resin film (D1) with a thickness of 75 m.

### Production of Laminate

A curable resin composition for a hard coat layer was applied to one surface of the obtained acrylic resin film, using a bar coater. Thereafter, the solvent was volatilized through drying at 80° C. for 2 minutes, irradiation was performed with an ultraviolet (UV) irradiator in a nitrogen atmosphere (with an oxygen concentration of 1% or less) with the integrated light quantity of UV irradiation being 460 mJ to form a hard coat layer (with a thickness of 5 m), thus obtaining a laminate. A composition in which reactive HALS (product name “ADK STAB LA-82” manufactured by ADEKA Corporation, also referred to as “LA82” hereinafter) was added to the coating material 1 to 2 parts with respect to 100 parts of the solid content of the coating material 1 was used as the curable resin composition for a hard coat layer.

### Example 2

Acrylic graft copolymer particles (A) having an average particle size of 80 nm produced in the same manner as in Reference Example 4 in JP 2004-137299A were used as graft copolymer particles (A-2), and poly(methyl methacrylate) (SUMIPEX (registered trademark) EX manufactured by Sumitomo Chemical Company, Limited) was used as acrylic resin (D-2). An acrylic resin film (D2) and a laminate were obtained in the same manner as in Example 1, except that 100 parts of a resin mixture 2 containing the graft copolymer particles (A-2) in an amount of 70% and the acrylic resin (D-2) in an amount of 30% were used, and the discharge amount from the T-die was 110 kg/hr.

### Example 3

A multilayer acrylic resin having an average particle size of 130 nm produced in the same manner as in Y-3 of Table 1 in JP 2015-7255A was used as graft copolymer particles (A-3). An acrylic resin film (D3) and a laminate were obtained in the same manner as in Example 1, except that 100 parts of a resin mixture 3 containing the graft copolymer particles (A-3) in an amount of 40% and the acrylic resin (D-2) in an amount of 60% were used.

### Example 4

Graft copolymer particles (A) having an average particle size of 80 nm produced in the same manner as in Manufacturing Example 1 in WO 2019/181752 were used as graft copolymer particles (A-4), and graft copolymer particles (B) having an average particle size of 230 nm produced in the same manner as in Manufacturing Example 12 in WO 2019/181752 were used as the graft copolymer particles (B-1). An acrylic resin film (D4) and a laminate were obtained in the same manner as in Example 1, except that 100 parts of a resin mixture 4 containing the graft copolymer particles (A-4) in an amount of 30%, the graft copolymer particles (B-1) in an amount of 4%, and the acrylic resin (D-2) in an amount of 66% were used.

### Comparative Example 1

An acrylic resin film and a laminate were obtained in the same manner as in Example 1, except that the coating material 1 was used as the curable resin composition for a hard coat layer.

### Comparative Example 2

An acrylic resin film and a laminate were obtained in the same manner as in Example 1, except that a composition in which a hydroxyphenyltriazine-based ultraviolet absorber (product name “Tinuvin (registered trademark) 400”, manufactured by BASF SE, also referred to as “Tinuvin 400” hereinafter) was added to the coating material 1 to 2 parts with respect to 100 parts of the solid content of the coating material 1 was used as the curable resin composition for a hard coat layer.

### Comparative Example 3

An acrylic resin film and a laminate were obtained in the same manner as in Example 1, except that a composition in which a hydroxyphenyltriazine-based ultraviolet absorber (product name “Tinuvin (registered trademark) 479”, manufactured by BASF SE, also referred to as “Tinuvin 479” hereinafter) was added to the coating material 1 to 2 parts with respect to 100 parts of the solid content of the coating material 1 was used as the curable resin composition for a hard coat layer.

### Comparative Example 4

An acrylic resin film and a laminate were obtained in the same manner as in Example 1, except that a composition in which Tinuvin 400 and HALS (product name “ADK STAB LA-81” manufactured by BASF SE, also referred to as “LA81” hereinafter) was added to the coating material 1 in amounts of 2 parts and 1 part respectively with respect to 100 parts of the solid content of the coating material 1 was used as the curable resin composition for a hard coat layer.

### Comparative Example 5

An acrylic resin film and a laminate were obtained in the same manner as in Example 1, except that a composition in which LA81 was added to the coating material 1 to 2 parts with respect to 100 parts of the solid content of the coating material 1 was used as the curable resin composition for a hard coat layer.

### Comparative Example 6

An acrylic resin film and a laminate were obtained in the same manner as in Example 1, except that a composition in which LA82 was added to the coating material 2 to 2 parts with respect to 100 parts of the solid content of the coating material 2 was used as a curable resin composition for a hard coat layer.

### Comparative Example 7

An acrylic resin film and a laminate were obtained in the same manner as in Example 2, except that the coating material 1 was used as the curable resin composition for a hard coat layer.

### Comparative Example 8

An acrylic resin film and a laminate were obtained in the same manner as in Example 2, except that a composition in which Tinuvin 400 was added to the coating material 1 to 2 parts with respect to 100 parts of the solid content of the coating material 1 was used as the curable resin composition for a hard coat layer.

### Comparative Example 9

An acrylic resin film and a laminate were obtained in the same manner as in Example 2, except that a composition in which Tinuvin 479 was added to the coating material 1 to 2 parts with respect to 100 parts of the solid content of the coating material 1 was used as the curable resin composition for a hard coat layer.

### Comparative Example 10

An acrylic resin film and a laminate were obtained in the same manner as in Example 2, except that a composition in which Tinuvin 400 and LA81 were added to the coating material 1 to 2 parts and 1 part respectively with respect to 100 parts of the solid content of the coating material 1 was used as the curable resin composition for a hard coat layer.

### Comparative Example 11

An acrylic resin film and a laminate were obtained in the same manner as in Example 1, except that a composition in which LA81 was added to the coating material 1 to 2 parts with respect to 100 parts of the solid content of the coating material 1 was used as the curable resin composition for a hard coat layer.

### Reference Example 1

An acrylic resin film produced in the same manner as in Example 1 was used as Reference Example 1.

### Reference Example 2

An acrylic resin film produced in the same manner as in Example 2 was used as Reference Example 2.

In the examples and the comparative examples, the crack elongation of the laminates at 120° C., ΔHz after stretched by 80% at 120° C., ΔHz after stretched by 20% at room temperature, haze, pencil hardness, chemical resistance, and weather resistance of the laminates were measured as described above, and the results are shown in Tables 1 and 2 below. In addition, in the examples and the comparative examples, the thickness, tensile elongation at break at 120° C., and glass transition temperatures of the acrylic resin films, and the thickness of the hard coat layers were measured as described above, and the results are shown in Tables 1 and 2. Tables 1 and 2 below also show the compositions of the hard coat layers, and the blend amounts are in parts by mass with respect to 100 parts by mass of the solid content of the coating material. Note that in the reference examples, the crack elongation of the acrylic resin film at 120° C., ΔHz after stretched by 80% at 120° C., ΔHz after stretched by 20% at room temperature, haze, pencil hardness, chemical resistance, and weather resistance were measured as described above, and the results are shown in the column “Laminate” in Table 2 below. In Tables 1 and 2 below, “-” means not measured.

TABLE 1

| | | | | Example | | | | Comparative Example | | | | |
|---|---|---|---|---|---|---|---|---|---|---|---|---|
| | | | | 1 | 2 | 3 | 4 | 1 | 2 | 3 | 4 | 5 |
| Acrylic | Thickness (μm) | | | 75 | 75 | 75 | 75 | 75 | 75 | | 75 | 75 |
| resin | Moldability | Tensile elongation at break | | 200% | 200% | 200% | 200% | 200% | 200% | 200% | 200% | 200% |
| film | | at 120° C. | | or more | or more | or more | or more | or more | or more | or more | or more | or more |
| | | Glass transition temperature (° C.) | | 105 | 107 | 109 | 117 | 105 | 105 | 105 | 105 | 105 |
| Hard coat | Coating material | | | 1 | 1 | 1 | 1 | 1 | 1 | 1 | 1 | 1 |
| layer | Blend amount | UVA | Tinuvin400 | | | | | | 2 | | 2 | |
| | (parts | | Tinuvin479 | | | | | | | 2 | | |
| | by mass) | HALS | LA81 | | | | | | | | 1 | 2 |
| | | Reactive HALS | LA82 | 2 | 2 | 2 | 2 | | | | | |
| | Thickness (μm) | | | 5 | 5 | 5 | 5 | 5 | 5 | 5 | 5 | 5 |
| Laminate | Moldability | Crack elongation at 120° C. (%) | | 150 | 150 | 150 | 150 | 150 | 150 | 150 | 150 | 150 |
| | Transparency | Haze | | 0.29 | 0.35 | 0.43 | 0.51 | — | — | — | — | — |
| | Hardness | Pencil hardness (load of 500 g) | | F | HB | HB | H | F | F | F | F | F |
| | Moldability | ΔHz after stretched by 20% at | | 1.2 | 0.2 | 4.2 | 24.4 | 1.2 | 1.2 | 1.2 | 1.2 | 1.2 |
| | | room temperature | | | | | | | | | | |
| | | ΔHz affer stretched by 80% at | | 0.9 | 1.5 | 0.8 | 0.4 | 0.9 | 0.9 | 0.9 | 0.9 | 0.9 |
| | | 120° C. | | | | | | | | | | |
| | Chemical | IPA drop test | | Good | Good | Good | Good | Good | Good | Good | Good | Good |
| | resistance | Acetone drop test | | Good | Good | Good | Good | Good | Good | Good | Good | Good |
| | Weather | Appearance | After 1000 | No | No | No | No | Yes | Yes | Yes | No | No |
| | resistance | (presence of | hours | | | | | | | | | |
| | | crack) | | | | | | | | | | |

| Color difference (ΔE) | | 0.3 | 0.3 | 0.3 | 0.3 | — | — | — | 0.3 | 0.3 |
|---|---|---|---|---|---|---|---|---|---|---|
| Appearance | After 2000 | No | No | No | No | — | — | — | Yes | Yes |
| (presence of | hours | | | | | | | | | |
| crack) | | | | | | | | | | |

| | | | | | | | | | |
|---|---|---|---|---|---|---|---|---|---|
| Color difference (ΔE) | 0.3 | 0.3 | 0.3 | 0.3 | — | — | — | — | — |

TABLE 2

| | | | | Comparative Example | | | | | | Reference Example | |
|---|---|---|---|---|---|---|---|---|---|---|---|
| | | | | 6 | 7 | 8 | 9 | 10 | 11 | 1 | 2 |
| Acrylic | Thickness (μm) | | | 75 | 75 | 75 | 75 | 75 | 75 | 75 | 75 |
| resin | Moldability | Tensile elongation at break | | 200% | 200% | 200% | 200% | 200% | 200% | 200% | 200% |
| film | | at 120° C. | | or more | or more | or more | or more | or more | or more | or more | or more |
| | | Glass transition temperature (° C.) | | 105 | 107 | 107 | 107 | 107 | 107 | 105 | 107 |
| Hard coat | Coating Material | | | 2 | 1 | 1 | 1 | 1 | 1 | | |
| layer | Blend amount | UVA | Tinuvin400 | | | 2 | | 2 | | | |
| | (parts | | Tinuvin479 | | | | 2 | | | | |
| | by mass) | HALS | LA81 | | | | | 1 | 2 | | |
| | | Reactive HALS | LA82 | 2 | | | | | | | |
| | Thickness (μm) | | | 5 | 5 | 5 | 5 | 5 | 5 | | |
| Laminate | Moldability | Crack elongation at 120° C. (%) | | 50 | 150 | 150 | 150 | 150 | 150 | 200% | 200% |
| | | | | | | | | | | or more | or more |
| | Transparency | Haze | | — | — | — | — | — | — | 0.34 | — |
| | Hardness | Pencil hardness (load of 500 g) | | F | HB | HB | HB | HB | HB | HB | B |
| | Moldability | ΔHz after stretched by 20% at | | — | 1.2 | 1.2 | 1.2 | 1.2 | 1.2 | 1.2 | — |
| | | room temperature | | | | | | | | | |
| | | ΔHz after stretched by 80% at | | 0.9 | 0.9 | — | — | — | — | 0.4 | 0.4 |
| | | 120° C. | | | | | | | | | |
| | Chemical | IPA drop test | | — | Good | Good | Good | Good | Good | Slightly | Poor |
| | resistance | | | | | | | | | poor | |
| | | Acetone drop test | | — | Good | Good | Good | Good | Good | Poor | Poor |
| | Weather | Appearance | After 1000 | — | Yes | Yes | Yes | No | No | No | No |
| | resistance | (presence of | hours | | | | | | | | |
| | | crack) | | | | | | | | | |

| Color difference (ΔE) | | — | — | — | — | 0.3 | 0.3 | 0.3 | 0.3 |
|---|---|---|---|---|---|---|---|---|---|
| Appearance | After 2000 | — | — | — | — | Yes | Yes | No | No |
| (presence of | hours | | | | | | | | |
| crack) | | | | | | | | | |

| | | | | | | | | |
|---|---|---|---|---|---|---|---|---|
| Color difference (ΔE) | — | — | — | — | — | — | 0.3 | 0.3 |

As can be seen from Table 1 above, the laminates of Examples 1 to 4 have a crack elongation of 100% or more at 120° C. and have good secondary moldability. Also, the laminates of Examples 1 to 4 had no cracks on the surfaces of the hard coat layers and the color difference was also 0.3 or less, even after 2000 hours of the accelerated weathering test, exhibiting good long-term weather resistance.

On the other hand, as can be seen from Tables 1 and 2 above, the laminates of Comparative Examples 1 to 5 and 7 to 11 in which the hard coat layer did not contain the reactive HALS had cracks on the surface of the hard coat layers after 1000 hours of the accelerated weathering test or 2000 hours of the accelerated weathering test, and had poor long-term weather resistance. In addition, the laminate of Comparative Example 6 in which a coating material having low stretchability was used for the curable resin composition for a hard coat layer had a crack elongation of less than 100% at 120° C., and had poor secondary moldability.

One or more embodiments of the present invention is not particularly limited, and may include, for example, the following embodiments.

[1] A laminate including: an acrylic resin film; and a hard coat layer laminated on at least one surface of the acrylic resin film,
wherein the acrylic resin film has a tensile elongation at break of 200% or more at 120° C.,
the hard coat layer is formed from a cured product of a curable resin composition including a urethane acrylate resin and a hindered amine light stabilizer having a reactive functional group, and
the laminate has a tensile crack elongation of 100% or more at 120° C.

[2] The laminate according to [1], wherein no crack is formed on a surface of the hard coat layer of the laminate after the laminate is subjected to an accelerated weathering test, in which the laminate is placed such that a hard coat layer side is located on a light source side, and direct sunlight is simulated using a xenon lamp as a light source, and 1000 test cycles (2000 hours in total) are performed under a condition of irradiance of 180 W/m² (300 to 400 nm), where one test cycle for 120 minutes in total includes a step 1 with an exposure time of 102 minutes, a black panel at 60° C.±3° C., a relative humidity of 65% 5%, and no rain, and a step 2 with an exposure time of 18 minutes, a chamber temperature of 38° C.±3° C., a relative humidity of 95%±5%, and with rain.

[3] The laminate according to [1] or [2], wherein the laminate has a pencil hardness of B or higher on the hard coat layer side under a load of 500 g, and an appearance of the laminate has no visible change when about 0.02 mL of isopropyl alcohol or acetone is dropped onto a surface of the hard coat layer and is left at 23° C. for 6 hours.

[4] The laminate according to any one of [1] to [3], wherein a color difference ΔE of the laminate after the accelerated weathering test (2000 hours in total) is performed is less than 0.5.

[5] The laminate according to any one of [1] to [4], wherein the urethane acrylate resin is curable with an active energy ray.

[6] The laminate according to any one of [1] to [5], wherein the reactive functional group comprises one or more selected from the group consisting of a methacryloyl group and an acryloyl group.

[7] The laminate according to any one of [1] to [6], wherein the curable resin composition comprises the hindered amine light stabilizer having a reactive functional group in an amount of 1 to 10 parts by mass with respect to 100 parts by mass of the urethane acrylate resin.

[8] A resin molded body including: the laminate according to any one of [1] to [7]; and a thermoplastic resin substrate, wherein at least a portion of the thermoplastic resin substrate surface is covered with the laminate located as the acrylic resin film side of the laminate is faced to a thermoplastic resin substrate surface.

[9] The resin molded body according to [8], wherein the thermoplastic resin substrate has a three-dimensional shape.

The embodiments described above are not independent of each other, and those skilled in the art can combine them as appropriate without the need for over-explanation. Furthermore, constituent elements of different embodiments may be combined as appropriate.

### DESCRIPTION OF REFERENCE NUMERALS

1 Laminate
2 Acrylic resin film
3 Hard coat layer

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A laminate comprising:
an acrylic resin film; and
a hard coat layer laminated on at least one surface of the acrylic resin film, wherein:
the acrylic resin film has a tensile elongation at break of 200% or more at 120° C.,
the hard coat layer is formed from a cured product of a curable resin composition comprising a urethane acrylate resin and a hindered amine light stabilizer having a reactive functional group, and
the laminate has a tensile crack elongation of 100% or more at 120° C.

2. The laminate according to claim 1, wherein:
no crack is formed on a surface of the hard coat layer of the laminate after the laminate is subjected to an accelerated weathering test,
the accelerated weathering test is conducted by:
placing the laminate such that a hard coat layer side is located on a light source side,
performing 1000 test cycles, which is 2000 hours in total, where one test cycle is conducted for 120 minutes in total, and includes:
a step 1 of exposing the laminate to the light source under an irradiance of 180 W/m² at a wavelength in a range of from 300 nm to 400 nm, with an exposure time of 102 minutes, a black panel at 60° C.±3° C., a relative humidity of 65%±5%, and no rain, and
a step 2 of exposing the laminate to the light source under the irradiance of 180 W/m² at the wavelength in the range of from 300 nm to 400 nm, with an exposure time of 18 minutes, a chamber temperature of 38° C.±3° C., a relative humidity of 95%±5%, and with rain,
where the light source is a xenon lamp as a simulated direct sunlight.

3. The laminate according to claim 1, wherein:
the laminate has a pencil hardness of B or higher on a hard coat layer side under a load of 500 g, and
subjecting the laminate to a solvent test results in no visible change in an appearance of the laminate, where the solvent test is conducted by dropping about 0.02 mL of isopropyl alcohol or acetone onto a surface of the hard coat layer and is left at 23° C. for 6 hours.

4. The laminate according to claim 2, wherein a color difference ΔE of the laminate, after the accelerated weathering test is performed for 2000 hours in total, is less than 0.5.

5. The laminate according to claim 1, wherein the urethane acrylate resin is curable with an active energy ray.

6. The laminate according to claim 1, wherein the reactive functional group comprises one or more selected from the group consisting of a methacryloyl group and an acryloyl group.

7. The laminate according to claim 1, wherein the curable resin composition comprises the hindered amine light stabilizer having a reactive functional group in an amount of from 1 part to 10 parts by mass with respect to 100 parts by mass of the urethane acrylate resin.

8. A resin molded body comprising:
the laminate according to claim 1; and
a thermoplastic resin substrate,
wherein:
at least a portion of a thermoplastic resin substrate surface is covered with the laminate, and
an acrylic resin film side of the laminate faces the thermoplastic resin substrate surface.

9. The resin molded body according to claim 8, wherein the thermoplastic resin substrate has a three-dimensional shape.

10. The resin molded body according to claim 8, wherein:
no crack is formed on a surface of the hard coat layer of the laminate after the laminate is subjected to an accelerated weathering test,
the accelerated weathering test is conducted by:
placing the laminate such that a hard coat layer side is located on a light source side,
performing 1000 test cycles, which is 2000 hours in total, where one test cycle is conducted for 120 minutes in total, and includes:
a step 1 of exposing the laminate to the light source under an irradiance of 180 W/m² at a wavelength in a range of from 300 nm to 400 nm, with an exposure time of 102 minutes, a black panel at 60° C.±3° C., a relative humidity of 65%±5%, and no rain, and
a step 2 of exposing the laminate to the light source under the irradiance of 180 W/m² at the wavelength in the range of from 300 nm to 400 nm, with an exposure time of 18 minutes, a chamber temperature of 38° C.±3° C., a relative humidity of 95%±5%, and with rain,
where the light source is a xenon lamp as a simulated direct sunlight.

11. The resin molded body according to claim 8, wherein:
the laminate has a pencil hardness of B or higher on a hard coat layer side under a load of 500 g, and
subjecting the laminate to a solvent test results in no visible change in an appearance of the laminate, where the solvent test is conducted by dropping about 0.02 mL of isopropyl alcohol or acetone onto a surface of the hard coat layer and is left at 23° C. for 6 hours.

12. The resin molded body according to claim 10, wherein a color difference ΔE of the laminate, after the accelerated weathering test is performed for 2000 hours in total, is less than 0.5.

13. The resin molded body according to claim 8, wherein the urethane acrylate resin is curable with an active energy ray.

14. The resin molded body according to claim 8, wherein the reactive functional group comprises one or more selected from the group consisting of a methacryloyl group and an acryloyl group.

15. The resin molded body according to claim 8, wherein the curable resin composition comprises the hindered amine light stabilizer having a reactive functional group in an amount of from 1 part to 10 parts by mass with respect to 100 parts by mass of the urethane acrylate resin.
